(19) United States
(12) Patent Application Publication
(10) Pub. No.: US 2013/0083255 A1
(43) Pub. Date: Apr. 4, 2013

(54) TELEVISION RECEIVER SYSTEM, STAND, AND ELECTRONIC DEVICE SYSTEM

(71) Applicants: Shinji Hiratomo, Tokyo (JP); Naohiro Yokoyama, Tokyo (JP)

(72) Inventors: Shinji Hiratomo, Tokyo (JP); Naohiro Yokoyama, Tokyo (JP)

(73) Assignee: KABUSHIKI KAISHA TOSHIBA, Tokyo (JP)

(21) Appl. No.: 13/587,766

(22) Filed: Aug. 16, 2012

(30) Foreign Application Priority Data
Sep. 30, 2011 (JP) 2011-218647

(51) Int. Cl. H04N 5/64

(52) U.S. Cl. 348/836; 348/E05.128; 348/E05.13

(57) ABSTRACT

According to one embodiment, a television receiver system includes: a housing configured to house a display unit comprising a display screen, the housing comprising an opening from which sound is output; and a stand detachably connected to the housing, the stand being configured to support the housing, the stand comprising a notch that is located corresponding to the opening and that constitutes at least a part of a propagation path of the sound output from the opening.

### CROSS-REFERENCE TO RELATED APPLICATIONS

This application is based upon and claims the benefit of priority from Japanese Patent Application No. 2011-218647, filed on Sep. 30, 2011, the entire contents of which are incorporated herein by reference.

### FIELD

Embodiments described herein relate generally to a television receiver system, a stand, and an electronic device system.

### BACKGROUND

There are conventionally known stands that introduce therein the sound of a speaker of a display unit and emit the sound.

This type of unit has been desired to have such a configuration as a simpler configuration that entails fewer disadvantages in sound output.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view illustrating a state in which a television receiver is held by a stand according to embodiments;

FIG. 2 is an exemplary perspective view illustrating the television receiver in the embodiments;

FIG. 3 is an exemplary front view illustrating the television receiver in the embodiments;

FIG. 4 is an exemplary rear view illustrating the television receiver in the embodiments;

FIG. 5 is an exemplary side view illustrating the television receiver in the embodiments;

FIG. 6 is an exemplary exploded perspective view illustrating the television receiver in the embodiments;

FIG. 7 is an exemplary plan view illustrating an internal configuration of the television receiver in the embodiments;

FIG. 8 is an exemplary sectional view taken along VIII-VIII in FIG. 3;

FIG. 9 is an exemplary side view illustrating the state in which the television receiver is held by the stand in the embodiments;

FIG. 10 is an exemplary rear view illustrating the state in which the television receiver is held by the stand in the embodiments;

FIG. 11 is an exemplary perspective view, viewed from the upper side, illustrating a stand according to a first embodiment;

FIG. 12 is an exemplary perspective view, viewed from another angle on the upper side, illustrating the stand in the first embodiment;

FIG. 13 is an exemplary sectional view taken along XIII-XIII in FIG. 1;

FIG. 14 is an exemplary sectional view taken along XIV-XIV in FIG. 1;

FIG. 15 is an exemplary perspective view illustrating a part of the stand in the first embodiment;

FIG. 16 is an exemplary exploded perspective view illustrating the stand in the first embodiment;

FIG. 17 is an exemplary sectional view taken along XVII-XVII in FIG. 1;

FIG. 18 is an exemplary view in which a part of FIG. 17 is enlarged;

FIG. 19 is an exemplary perspective view illustrating a part of an internal configuration of the stand in the first embodiment;

FIG. 20 is an exemplary sectional view taken along XX-XX in FIG. 1;

FIG. 21 is an exemplary sectional view illustrating a part of a state in which the television receiver is held by a stand according to a first variation;

FIG. 22 is an exemplary perspective view illustrating a television receiver system according to a second variation;

FIG. 23 is an exemplary rear view illustrating a state in which the television receiver is held by a stand according to a third variation;

FIG. 24 is an exemplary side view illustrating a state in which the television receiver is held by a stand according to a fourth variation;

FIG. 25 is an exemplary sectional view, viewed from above, illustrating a state in which the television receiver is held by a stand according to a fifth variation;

FIG. 26 is an exemplary perspective view illustrating a part of a television receiver system according to a sixth variation;

FIG. 27 is an exemplary side view illustrating a state in which the television receiver is held by a stand in the sixth variation;

FIG. 28 is an exemplary perspective view illustrating a part of a television receiver system according to a seventh variation;

FIG. 29 is an exemplary sectional view illustrating a part of a state in which the television receiver is held by a stand in the seventh variation;

FIG. 30 is an exemplary rear view illustrating a state in which the television receiver is held by a stand according to an eighth variation; and

FIG. 31 is an exemplary front view illustrating a state in which the television receiver is held by a stand according to a ninth variation.

### DETAILED DESCRIPTION

In general, according to one embodiment, a television receiver system comprises: a housing configured to house a display unit comprising a display screen, the housing comprising an opening from which sound is output; and a stand detachably connected to the housing, the stand being configured to support the housing, the stand comprising a notch that is located corresponding to the opening and that constitutes at least a part of a propagation path of the sound output from the opening.

A plurality of exemplary embodiments including variations described below comprise components of the same type. Accordingly, in the description below, common reference numerals are assigned to components of the same type, and duplicate description will be omitted. In the drawings, directions (X, Y, and Z directions) are indicated for convenience. The X direction is a lengthwise direction in the front view of a display screen of a television receiver; the Y direction is a traverse direction in the front view of the display screen; and the Z direction is a front-rear direction (depth direction, or thickness direction of housing) in the front view of the display screen. The X, Y, and Z directions are perpendicular to each other.

Although cases will be exemplified in which an electronic device is configured as a television receiver in the embodiments described below, the electronic device according to the present embodiments is not limited to those cases. The electronic device in the present embodiments can be configured as one of various electronic devices, such as a personal computer of a tablet type, a slate type, a notebook type, or a desktop type, a smartphone, a smart TV, a smartbook, a mobile phone, a PDA (personal digital assistant), a video display device, and a videophone.

### First Embodiment

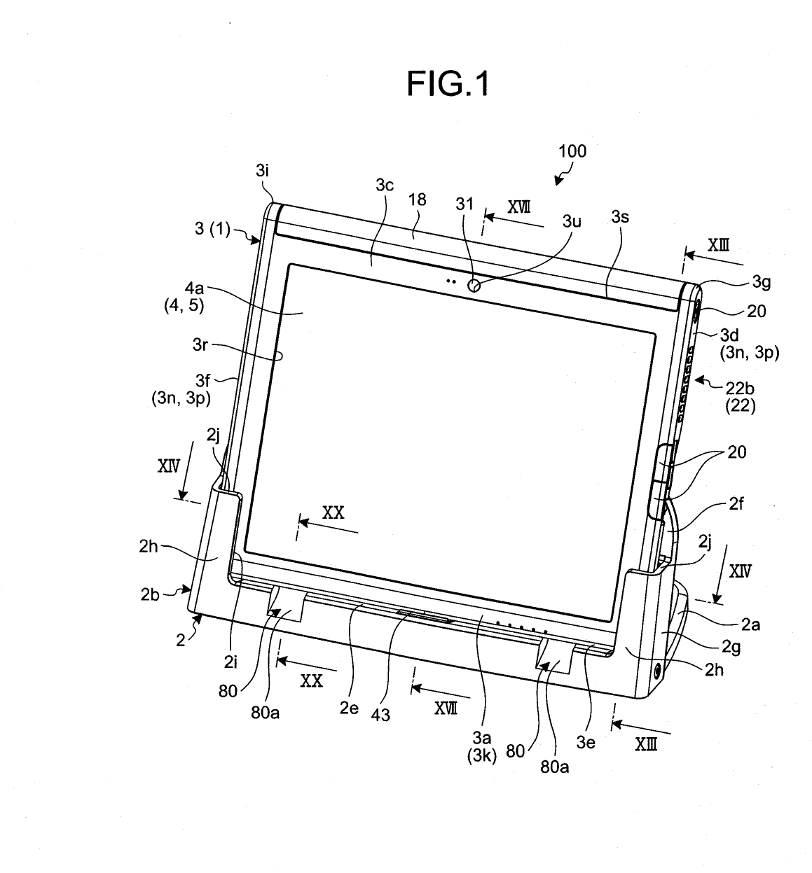

In the present embodiment, as an example, a television receiver 1 which is an example of an electronic device is mounted on a stand 2 which is an example of a support, thus configuring a television receiver system (electronic device system) 100, as illustrated in FIG. 1. In the present embodiment, when connected to the television receiver (electronic device) 1, the stand 2 (support) can add functions that are not provided by the television receiver 1, or extend or enhance functions that are provided by the television receiver 1 in such a way, for example, that connectors for the television receiver 1, that is, connectors electrically connected to circuits or the like in the television receiver 1 are added, or the connectors are increased in number. That is, the stand 2 (support) is an example of a function extending device corresponding to the television receiver (electronic device) 1.

The stand 2 supports a housing 3 of the television receiver 1, where the housing 3 houses a display unit 4. That is, the stand 2 is an example of a support device (support platform, or docking station) of the television receiver 1. The stand 2 comprises a mechanism (not shown in FIG. 1) that can adjust an angle of a display screen 4a of the display unit 4. That is, the stand 2 is an example of an angle adjusting device for the display screen 4a (housing 3 housing the display unit 4).

Television Receiver [Electronic Device]

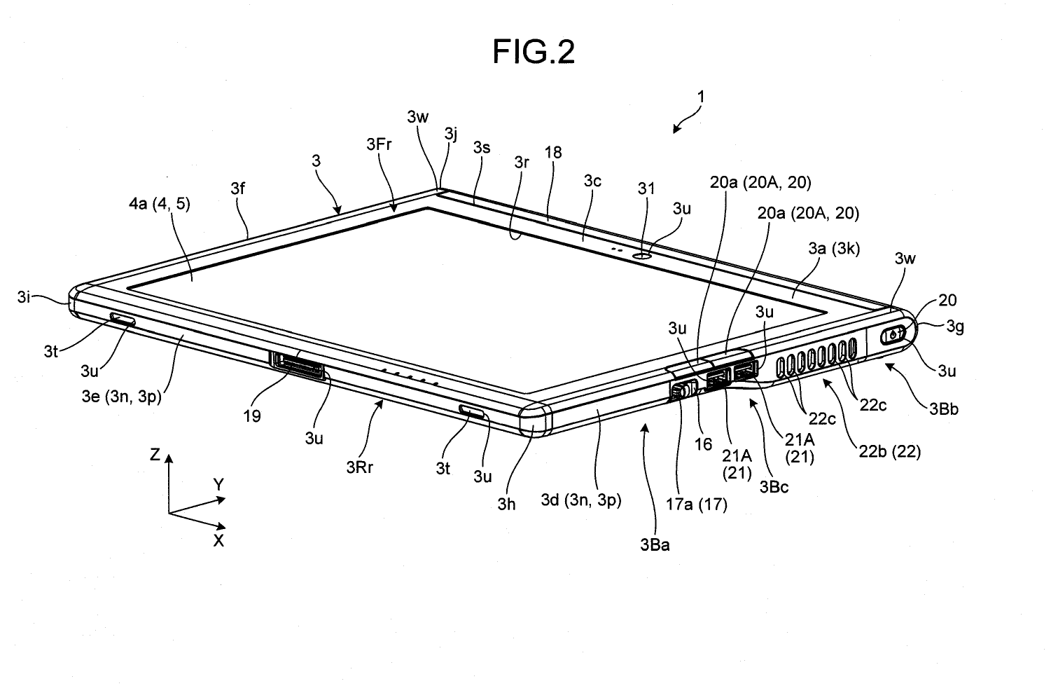

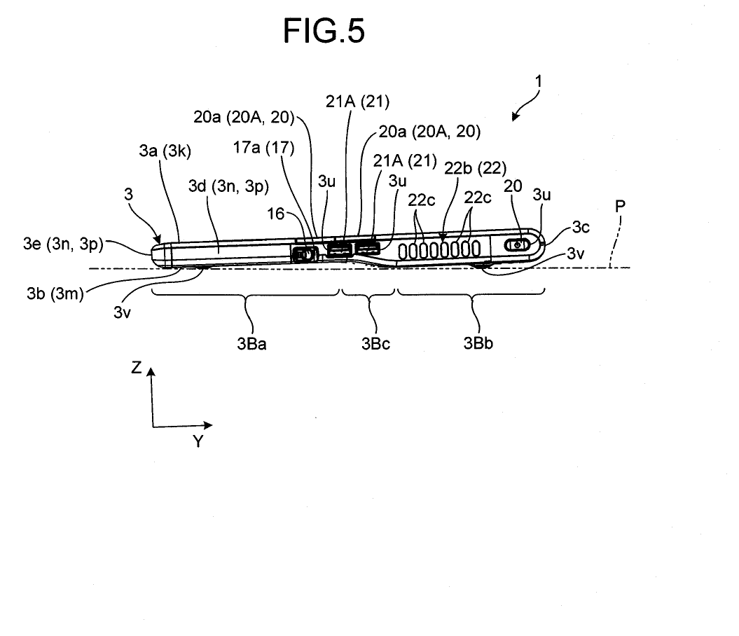

In the present embodiment, as an example, the housing 3 of the television receiver 1 is configured, as illustrated in FIGS. 1 to 4, to have a rectangular shape (non-square rectangular shape as an example in the present embodiment) in the front and rear views. In the present embodiment, as an example, the housing 3 is also configured, as illustrated in FIGS. 2 and 5, to have a flat rectangular cuboid shape that is thin in the front-rear direction. The housing 3 comprises a front surface (front, surface, first surface, or first surface module) 3a and a rear surface (rear, surface, second surface, or second surface module) 3b on the opposite side of the front surface. The front surface 3a and the rear surface 3b are substantially alongside each other. The housing 3 also comprises, as illustrated in FIGS. 2 to 4, four ends (sides, or edges) 3c to 3f and four corners (apexes, curves, or ends) 3g to 3j, in the front view. The ends 3c and 3e are examples of longer sides. The ends 3d and 3f are examples of shorter sides.

The housing 3 also comprises a wall (first wall portion, first portion, plate, frame, front wall, face wall, or top wall) 3k comprising the front surface 3a, and a wall (second wall portion, second portion, plate, rear wall, back wall, or bottom wall) 3m comprising the rear surface 3b. The walls 3k and 3m have each a rectangular shape (non-square rectangular shape as an example in the present embodiment). The housing 3 also comprises four walls (third wall portions, third portions, plates, side walls, end walls, standing walls, or bridging modules) 3n comprising each a side surface (surface, peripheral surface, or third surface) 3p provided in a bridging manner between the wall 3k and the wall 3m. The wall 3k is provided with an opening 3r having a rectangular shape as an example.

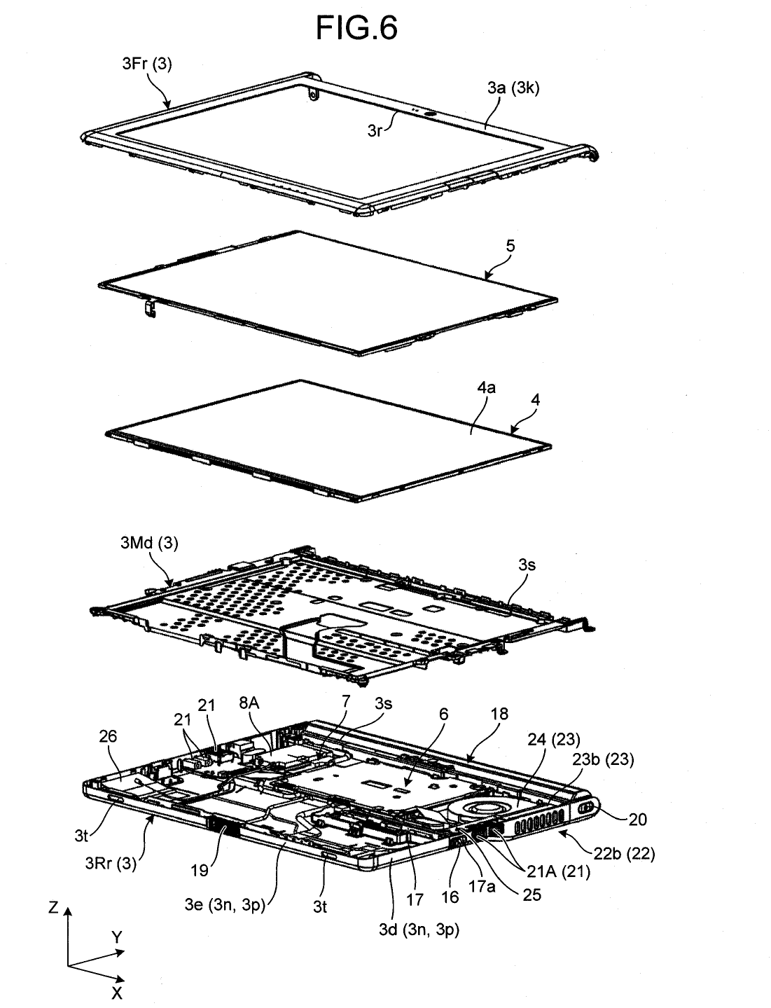

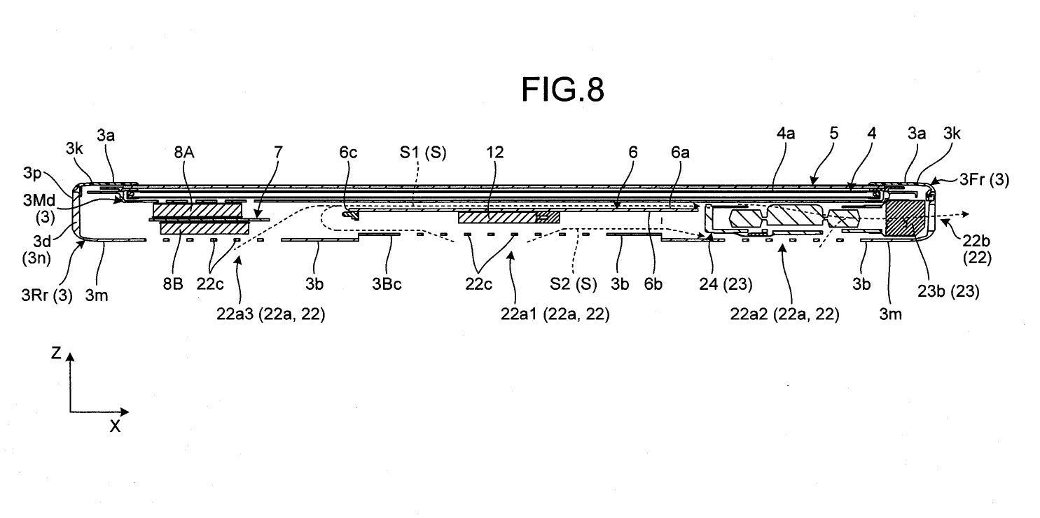

The housing 3 can be configured by combining a plurality of components (divided bodies). In the present embodiment, as an example, the housing 3 comprises a first member (first portion, front member, or cover) 3Fr that comprises at least the wall 3k, and a second member (second portion, rear member, base, or bottom) 3Rr that comprises at least the wall 3m. The walls 3n are comprised in at least one of the first member 3Fr and the second member 3Rr (for example, in the second member 3Rr). In the present embodiment, as illustrated in FIGS. 6 and 8, in addition to the first member 3Fr and the second member 3Rr, the housing 3 comprises a third member (third portion, intermediate member, dividing member, barrier member, wall member, interposed member, inner plate, middle plate, or middle frame) 3Md that is located between the first and the second members. A part of the walls 3n can be comprised in the third member 3Md. The housing 3 can be composed of, for example, metallic material or synthetic resin material. As an example, the second member 3Rr and the third member 3Md can be composed of a relatively high-stiffness material (for example, metallic material such as magnesium alloy), and the first member 3Fr can be composed of a relatively low-stiffness material (material, such as synthetic resin material, having a lower stiffness than that of the second member 3Rr and the third member 3Md). Note that the first member 3Fr, the second member 3Rr, and the third member 3Md can comprise walls (projections, or projecting walls) such as ribs. The walls are likely to increase the stiffness of the housing 3. The third member 3Md can also be provided with openings such as through-holes. The housing 3 can be configured to be lighter in weight by the openings.

In the present embodiment, as an example, as illustrated in FIG. 5, a first portion 3Ba located on the lower side or front side (near side to the user) in the state in which the television receiver 1 is used with the longer side thereof oriented sideways has a thickness smaller than that of a second portion 3Bb located on the upper side or rear side (far side from the user) in the same state. Therefore, in the state in which the television receiver 1 is used while being placed on a placing surface P such as a desk, the front surface 3a of the housing 3 and the display screen 4a increase in height from the placing surface (horizontal surface) Pas a position thereof changes from the front side (lower side) to the rear side (upper side). Consequently, according to the present embodiment, as an example, there is an advantage that the display screen 4a is placed in a so-called tilted state for the user positioned on the left side of FIG. 5 relative to the television receiver 1, and thus, the user can easily view the display screen 4a. In the state of FIG. 5, the display screen 4a and the placing surface P can form an angle (on the obtuse angle side) of 135° or more and less than 180°. In the present embodiment, as an example, the rear surface 3b of the housing 3 comprises a plurality of projections 3v (3v, 3v). As is demonstrated by FIG. 5, the distance between a tip portion of the projection 3v located at the second portion 3Bb on the right side of FIG. 5 and the display screen 4a is greater than the distance between a tip portion of the projection 3v located at the first portion 3Ba on the left side of FIG. 5 and the display screen 4a. In the present embodiment, (the tip portion of) the projection 3v on the left side of FIG. 5 is an example of a first contact portion, and (the tip portion of) the projection 3v on the right side of FIG. 5 is an example of a second contact portion.

The housing 3 comprises a component housing 17 that houses a component 16 in a removable manner. In the present embodiment, as an example, an opening 17a of the component housing 17 opens at the end 3d. The opening 17a is provided in the end 3d which is located on the upper side in some in-use attitude (in the above-described example, a first attitude or a second attitude), and which is not located on the lower side in a non-use attitude. With such a configuration, the opening 17a is located on the upper side in an in-use attitude. Consequently, as an example, it is easy to prevent the component 16 from coming off from the component housing 17 by an action of gravity. Specifically, the component 16 is, for example, a stylus, a stylus pen, or a pen.

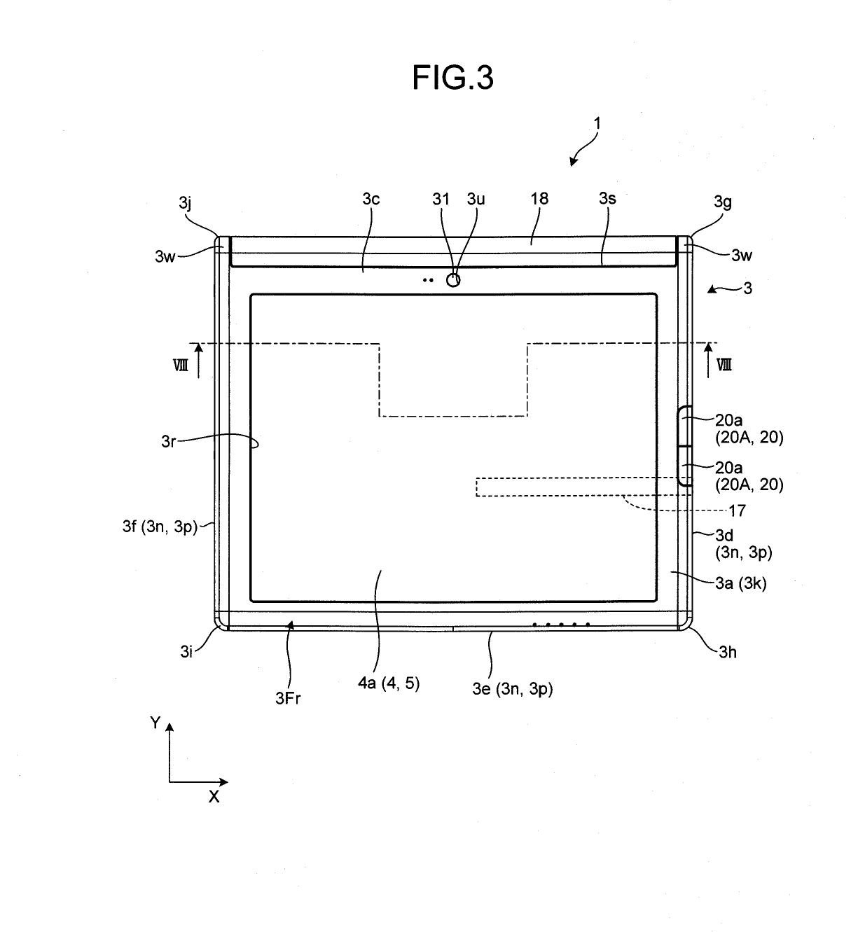

In the present embodiment, as an example, as illustrated in FIG. 3, a battery 18 and the display unit 4 are arranged side by side in a direction perpendicular to the thickness direction of the housing 3 (in a direction along the front surface 3a or the rear surface 3b, that is, in the X or Y direction; in the present embodiment, as an example, in the Y direction) without overlapping each other in the thickness direction. Consequently, as an example, the housing 3 can be configured to be thinner than in the case in which the battery 18 and the display unit 4 overlap each other in the thickness direction of the housing 3. Alternatively, as an example, compared with the case in which the battery 18 and the display unit 4 overlap each other in the thickness direction of the housing 3, the battery 18 can easily be thicker, and consequently, a capacity per unit volume of the battery 18 can easily be increased. As illustrated in FIG. 5, in the present embodiment, the housing 3 comprises the thin first portion 3Ba and the thick second portion 3Bb. A battery housing (battery support) 3s housing the battery 18 is provided at the end 3c of the thick second portion 3Bb. Therefore, as an example, compared with the case in which the battery housing 3s is provided at the first portion 3Ba, the battery can easily be thick, and consequently, a charging capacity per unit volume of the battery 18 can easily be increased.

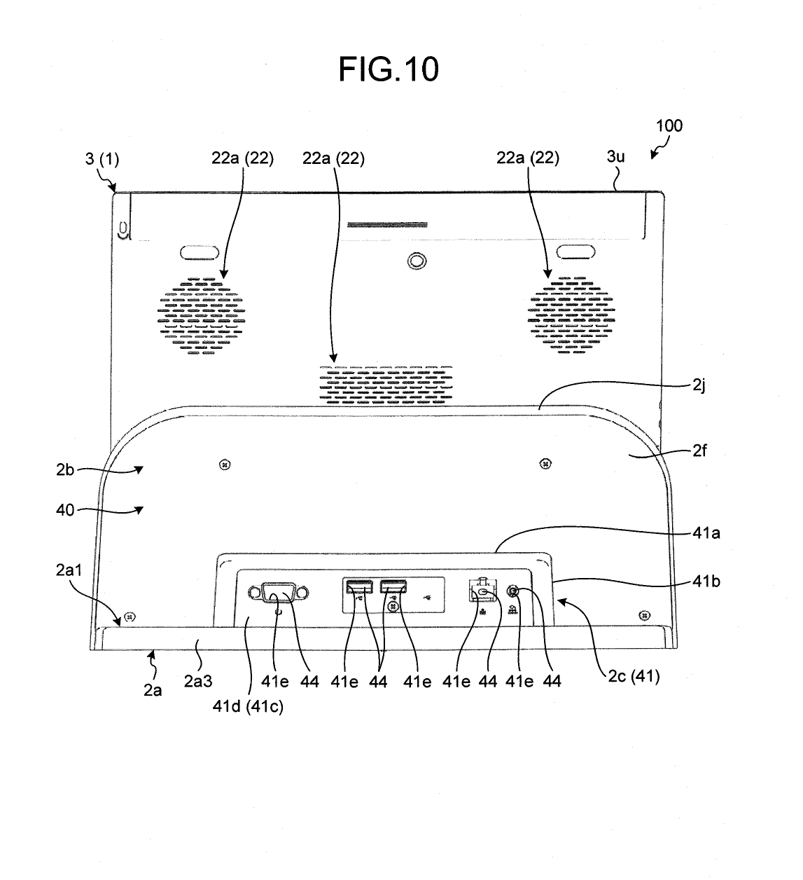

In the present embodiment, as an example, the end 3e on the opposite side of the end 3c provided with the battery housing 3s is supported by the stand 2. Consequently, as an example, the operator (such as the user) can mount and remove the battery 18 to and from the housing 3 in the state in which the television receiver 1 is supported by the stand 2. The end 3e comprises, as illustrated in FIGS. 2 and 3, a connector 19 that is connected to a connector 43 (refer to, for example, FIGS. 10 and 11) of the stand 2. Consequently, as an example, the battery housing 3s and the connector 19 can easily be provided at the housing 3 without interfering each other. Speaker covers 3t are exposed at the end 3e. The connector 19 and the speaker covers 3t are exposed via openings 3u provided in the wall 3n at the end 3e. The connector 19 is an example of a first connector.

In the present embodiment, as an example, as illustrated in FIGS. 2, 3, 5, and 6, the front surface 3a and the side surfaces 3p of the housing 3 comprise operation modules 20 and connectors 21. The operation modules 20 can be, for example, pushbuttons, push switches, slide switches, and pointing devices. The connectors 21 are, for example, a connector for a power cable, USB connectors, connectors for an earphone and a microphone. The operation modules 20 and the connectors 21 are exposed via the openings 3u provided in the walls 3k and 3n of the housing 3. The front surface 3a can comprise a camera (camera module, or image-taking device).

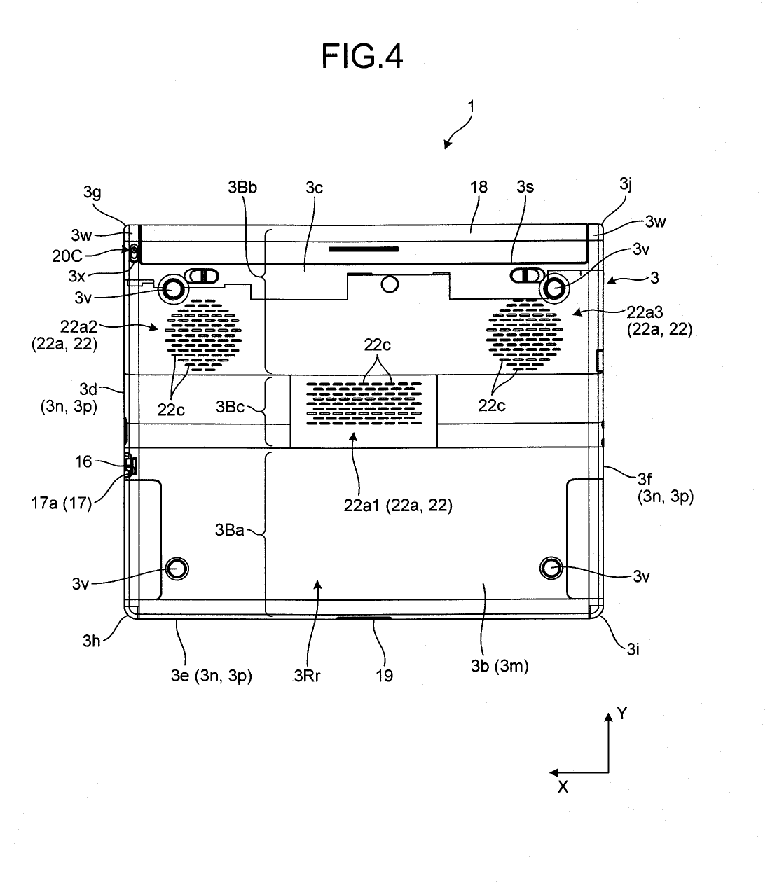

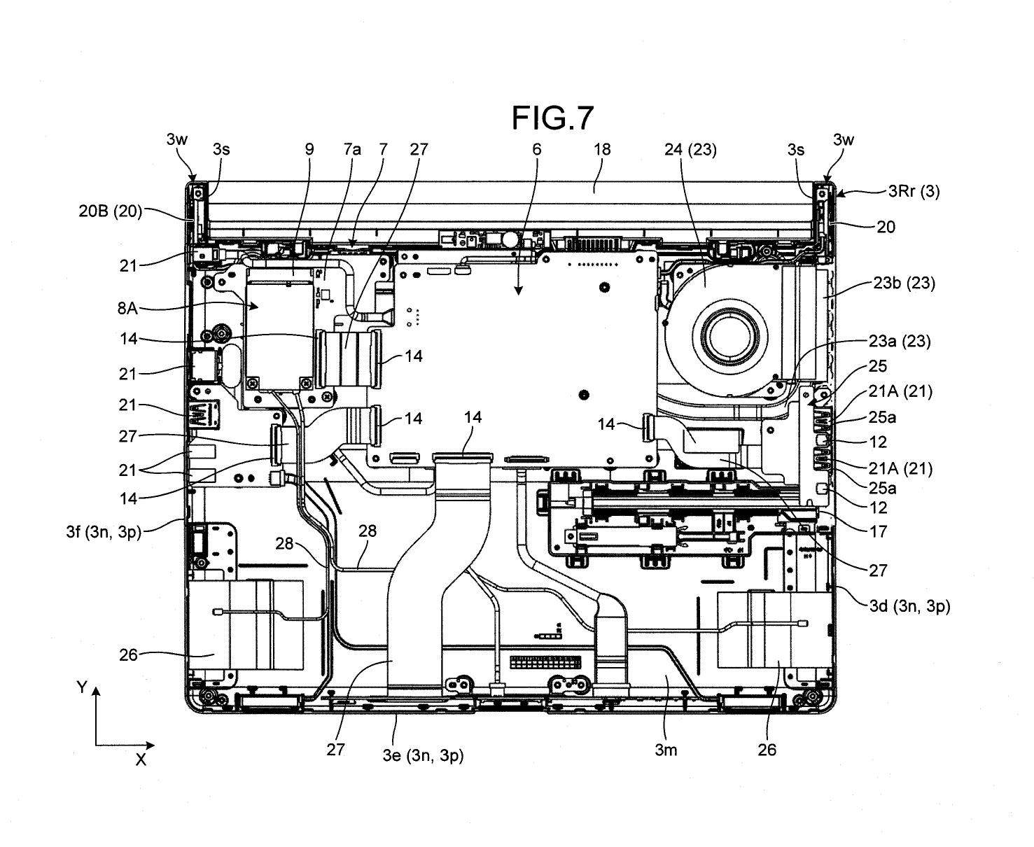

In the present embodiment, as an example, as illustrated in FIGS. 2, 4 to 6, and 8, the rear surface 3b and the side surface 3p of the housing 3 is provided with vent holes 22 that introduce or exhaust air used for, for example, cooling electronic components 12 (refer to, for example, FIG. 8). In the present embodiment, as an example, the rear surface 3b (wall 3m) is provided with introduction ports 22a that introduce air, and the side surface 3p (wall 3n, end 3d) is provided with an exhaust port 22b that exhausts air. In the present embodiment, the introduction ports 22a and the exhaust port 22b are provided as portions in which a plurality of small openings 22c provided in the walls 3m and 3n are grouped together. Note that the rear surface 3b comprises the projections 3v. Therefore, the introduction ports 22a are not closed even in the state in which the rear surface 3b is placed on the placing surface P, as illustrated in FIG. 5. In the present embodiment, a boundary portion between the thin first portion 3Ba and the thick second portion 3Bb of the housing 3 comprises a slope portion 3Bc. In addition, as illustrated in FIG. 4, one introduction port 22a1 of the introduction ports 22a is provided at the rear surface 3b at the slope portion 3Bc. As illustrated in FIG. 5, the distance between the slope portion 3Bc and the placing surface P is greater than the distance between the other portions and the placing surface P. Therefore, the introduction port 22a1 provided at the slope portion 3Bc can easily have the reduced air-flow resistance, and thus, the cooling efficiency can easily be increased. Moreover, in the present embodiment, the introduction ports 22a are provided in plurality. Therefore, as an example, even if one of the introduction ports 22a is closed due to some cause, the other introduction ports 22a can introduce air flows into the housing 3, and thus, the cooling performance is hardly impaired. The inside of the housing 3 may be cooled by a cooling mechanism 23 (refer to, for example, FIGS. 7 and 8), or by natural cooling (convection cooling).

In the present embodiment, as an example, as illustrated in FIGS. 6 and 8, the display unit (display module, display, or panel) 4 is housed between the first member 3Fr and the third member 3Md. The display screen 4a located on the side of the front surface 3a relative to the display unit 4 is exposed in front (outside) of the housing 3 via the opening 3r. Thus, the user can view the display screen 4a from the front side through the opening 3r. The display unit 4 is configured to have a rectangular shape (non-square rectangular shape as an example in the present embodiment) in the front view. The display unit 4 is also configured to have a flat rectangular cuboid shape that is thin in the front-rear direction. The display unit 4 is, for example, a liquid crystal display (LCD) or an organic electro-luminescent display (GELD).

In the present embodiment, as an example, the display unit 4 comprises, in front (on the face side, or on the side of the wall 3k) thereof, a transparent input operation panel (touchscreen, touch sensor, or operation surface as an example) 5 having a relatively thin rectangular shape. The input operation panel 5 covers the display screen 4a. The operator (such as the user) can execute input processing by performing operation such as touching, pressing, or dragging the input operation panel 5 with a finger or the component 16 (stylus), or moving the finger or the stylus near the input operation panel 5. Light emitted from the display screen 4a of the display unit 4 goes out from the opening 3r of the wall 3k to the front (outside) of the housing 3 through the input operation panel 5. The input operation panel 5 is an example of an input module.

In the present embodiment, as an example, as illustrated in FIG. 6, a plurality of boards 6, 7, and 25 are housed at the rear (on the back side, on the behind side behind, on the side of the wall 3m, or on the side opposite to the display screen 4a) of the display unit 4 (in the present embodiment, as an example, between the second member 3Rr and the third member 3Md) in the housing 3. The boards 6, 7, and 25 are located in positions different from each other. All of the boards are provided alongside the display unit 4. The boards 6, 7, and 25 are also provided in a state separated from the walls 3k, 3m, and 3n, that is, in the state in which spaces are provided between themselves and the walls 3k, 3m, and 3n. The boards 6, 7, and 25 are arranged along the display unit 4, and can be arranged so as not to overlap each other in the thickness direction of the housing 3. The boards 6, 7, and 25 are fixed to the housing 3 by fixing devices such as screws.

In the present embodiment, as an example, the board (first board, first circuit board, control board, or main board) 6 can be mounted with the plurality of electronic components 12 (refer to FIG. 8, which illustrates only a part), such as a CPU (central processing unit), a graphic controller, power supply circuit components, a PCH (platform controller hub), a memory slot connector, an LCD connector, an I/O (input/output) connector, a power coil, devices, and connectors. The electronic components 12 comprise heat generating bodies. The electronic components (heat generating bodies) 12 generating a large amount of heat can comprise the cooling mechanism 23. The cooling mechanism 23 comprises, for example, a heat sink (heat receiving module, not shown), a heat pipe 23a, a heat radiation module 23b, and a fan 24. At least a part of a control circuit (not shown) is composed of the board 6 and the electronic components 12. The control circuit can comprise, for example, a video signal processing circuit, a tuner module, an HDMI (high-definition multimedia interface) signal processor, an AV (audio video) input terminal, a remote-control signal receiver, a controller, a selector, an on-screen display interface, memories (such as a ROM [read-only memory], a RAM [random access memory], an HDD [hard disk drive], and an SSD [solid state drive]), and an audio signal processing circuit. The control circuit controls, for example, output of images (such as an animation and a still image) on the display screen 4a of the display unit 4, output of sounds from speakers (not shown), and emission of light from LEDs (light emitting diodes, not shown). The display unit 4, the speakers, and the LEDs are examples of output modules.

As can be understood from FIGS. 3, 4, and 8, in the present embodiment, as an example, the boards 6 and 7, and the cooling mechanism 23 are located at the thick second portion 3Bb of the housing 3. Consequently, as an example, compared with the case in which the boards 6 and 7, and the cooling mechanism 23 are located at the thin first portion 3Ba, a larger space can easily be ensured, and thus, it is easier to obtain a cooling effect by air flows generated by the fan 24 of the cooling mechanism 23. In the present embodiment, as an example, the fan 24 and the heat radiation module 23b are provided at the corner 3g where the end 3d is connected to the end 3c that is located on the upper side in the specified (controlled) in-use state. Therefore, as an example, the fan 24 and the heat radiation module 23b can be arranged on the upper side in the housing 3 regardless of the in-use attitude of the television receiver 1. Consequently, as an example, heat hardly accumulates in the housing 3. Note that the fan 24 and the heat radiation module 23b are provided adjacent to the exhaust port 22b.

In the present embodiment, as an example, the board 7 is provided at a location where the board 6 is interposed between the board 7 and the cooling mechanism 23 (at a location where the board 7, the board 6, and the cooling mechanism 23 are disposed in this order in the second portion 3Bb). With such a configuration, the air drawn from outside hits the board 7 before reaching the position of the board 6. Consequently, as an example, the board 7 is likely to have high heat radiation efficiency. The board 7 mounted with modules 8A and 8B is located on the side opposite to the cooling mechanism 23 which is another heavy object, relative to the board 6 which has a relatively large weight among components in the housing 3 and which is located in the middle of the housing 3. Therefore, as an example, the television receiver 1 has a better weight balance. Consequently, as an example, the user can hold the television receiver 1 more easily when carrying it.

In the present embodiment, as an example, as illustrated in FIGS. 4 and 8, the wall 3m of the housing 3 is provided with an introduction port 22a2 near the fan 24, an introduction port 22a3 located on the side opposite to the introduction port 22a2 with the board 6 interposed therebetween, and the introduction port 22a1 that is located nearer to the electronic components 12 as heat generating bodies than are the introduction ports 22a2 and 22a3. Because the introduction port 22a2 is provided, air flows can be generated more efficiently in the housing 3. An air flow S introduced from the introduction port 22a3 is divided into an air flow S2 that flows along a second surface 6b at the rear of the board 6 toward the fan 24, and an air flow 51 that passes through (wraps around, or detours around) the outside of an end 6c located on the side opposite to the fan 24 relative to the board 6 and flows along a first surface 6a in front of the board 6 toward the fan 24. Consequently, the electronic components (heat generating bodies) 12 provided on both side of the first surface 6a and the second surface 6b of the board 6 can be cooled.

In the present embodiment, as an example, as illustrated in FIG. 8, the board 7 and the modules 8A and 8B are arranged along the display unit 4. The board 25 is provided with the electronic components 12. The housing 3 houses flexible cables 27. The flexible cables 27 electrically connect the boards 6, 7, and 25, the display unit 4, and the connector 19 to each other. The flexible cables 27 are, for example, flexible printed wiring boards and flat cables.

As illustrated in FIG. 7, the housing 3 houses a plurality of antennas 26. In the present embodiment, the plurality of antennas 26 connected to one communication module (for example, the module 8B) are arranged in a mutually spaced manner. In the present embodiment, as an example, one of the antennas 26 is arranged near the end 3d and the end 3e (near the corner 3h) of the housing 3 while the other of the antennas 26 is arranged near the end 3e and the end 3f (near the corner 3i) of the housing 3. With this arrangement, as an example, a spatial diversity of the antennas 26 can be formed. The antennas 26 are electrically connected to the module 8B via cables 28. Note that the plurality of antennas 26, 26 can be used for separate functions. For example, one of the antennas 26 can be used for send and receive while the other of the antennas 26 can be used for receive only, or one of the antennas 26 can be used as a backup for the other of the antennas 26.

Stand

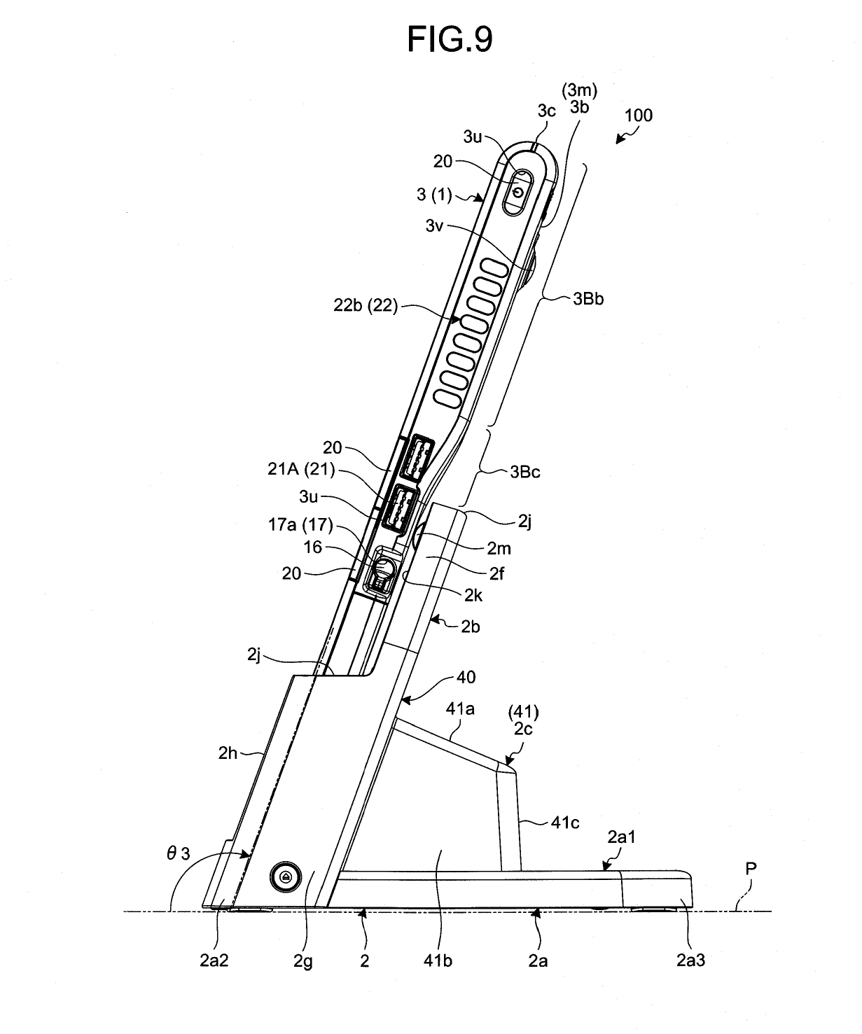

In the present embodiment, as an example, the stand 2 comprises a first support 2a and a second support 2b, as illustrated in FIG. 9. The first support 2a is placed on the placing surface P (refer to FIG. 9), and serves as a foundation (platform, bottom, lower module, ground, base, base module, placing module, leg module, leg, tipping suppression module, or suppression module). The second support 2b projects from (a bottom of) the first support 2a to above the placing surface P, and holds the housing 3 of the television receiver 1 in a predetermined attitude (position). That is, the second support 2b serves as a holder (stand, vertical module, upper module, receiving portion, holding portion, cover, abutment, contact portion, or guide). Note that the first support 2a and the second support 2b need not be distinctly divided into components, but may be, for example, portions of a component. In the present embodiment, as an example, the stand 2 also comprises a projection 2c that is located between the first support 2a and the second support 2b and that projects toward above the first support 2a and behind the second support 2b. The projection 2c has a function as a component housing 41 that houses components, and is interposed between the first support 2a and the second support 2b so as to serve as a support supporting the second support 2b. The stand 2, the first support 2a, the second support 2b, and the projection 2c are examples of the support that supports the television receiver (electronic device) 1. The first support 2a, the second support 2b, and the projection 2c can be embodied in various specifications (such as shapes, structures, and numbers). The stand 2 is connected mechanically and electrically to the television receiver (electronic device) 1 located in a predetermined position (mounting position, holding position, or placing position) of the stand 2.

The stand 2 can provide various functions related to the television receiver (electronic device) 1 mounted thereon. The stand 2 can have, for example, a function to support (hold) the display screen 4a in a standing state. In that case, the stand 2 can have a function to variably set the angle of the display screen 4a (attitude of the television receiver 1). This function will be described later. The stand 2 can also serve, for example, as a battery charger for the television receiver 1. In that case, the stand 2 can serve either as a wired battery charger that is electrically connected to the television receiver 1, or as a battery charger that performs contactless charging (wireless power supply). In that case, a contactless charger is provided in the second support 2b, as an example. The stand 2 can also serve, for example, as a connector module (hub for connectors, and/or relay device for data and signals) that increases the number of connectors electrically connected to the television receiver 1. The stand 2 can also serve, for example, as a speaker of the television receiver 1. The stand 2 can also be provided with, for example, a function for cooling the television receiver 1. In that case, as an example, a ventilation passage and a fan are provided in a housing 40 of the stand 2, and thus, air passing through the ventilation passage can assist or facilitate the cooling of the television receiver 1. The ventilation passage can have an opening facing the vent holes 22 of the television receiver 1. As an example, the stand 2 may comprise a cooler facing the television receiver 1. The stand 2 can also be provided with, for example, a function as an AC adapter.

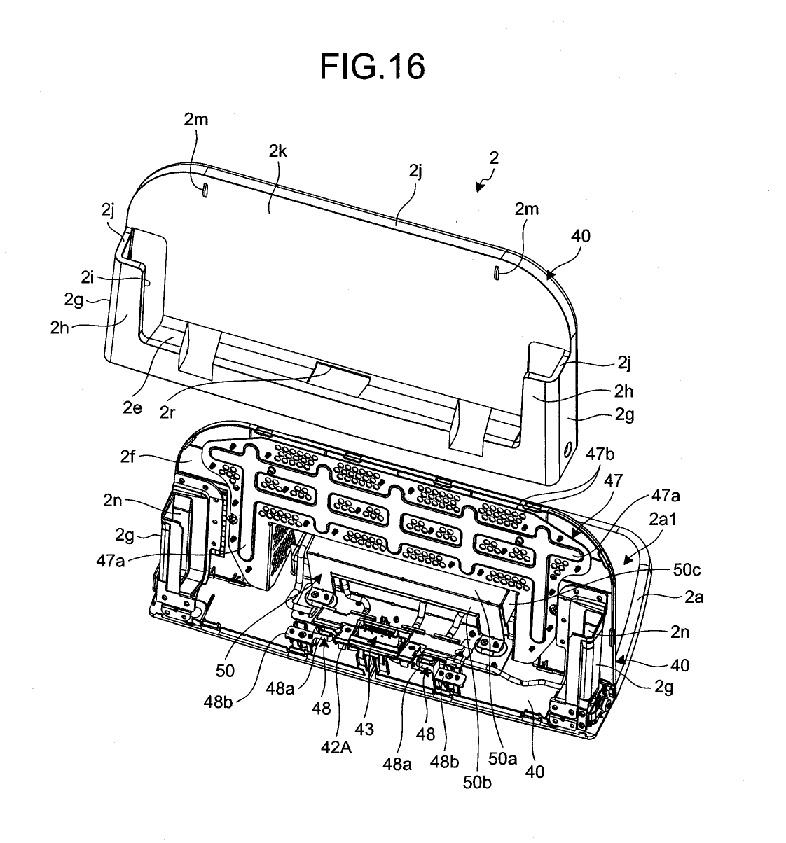

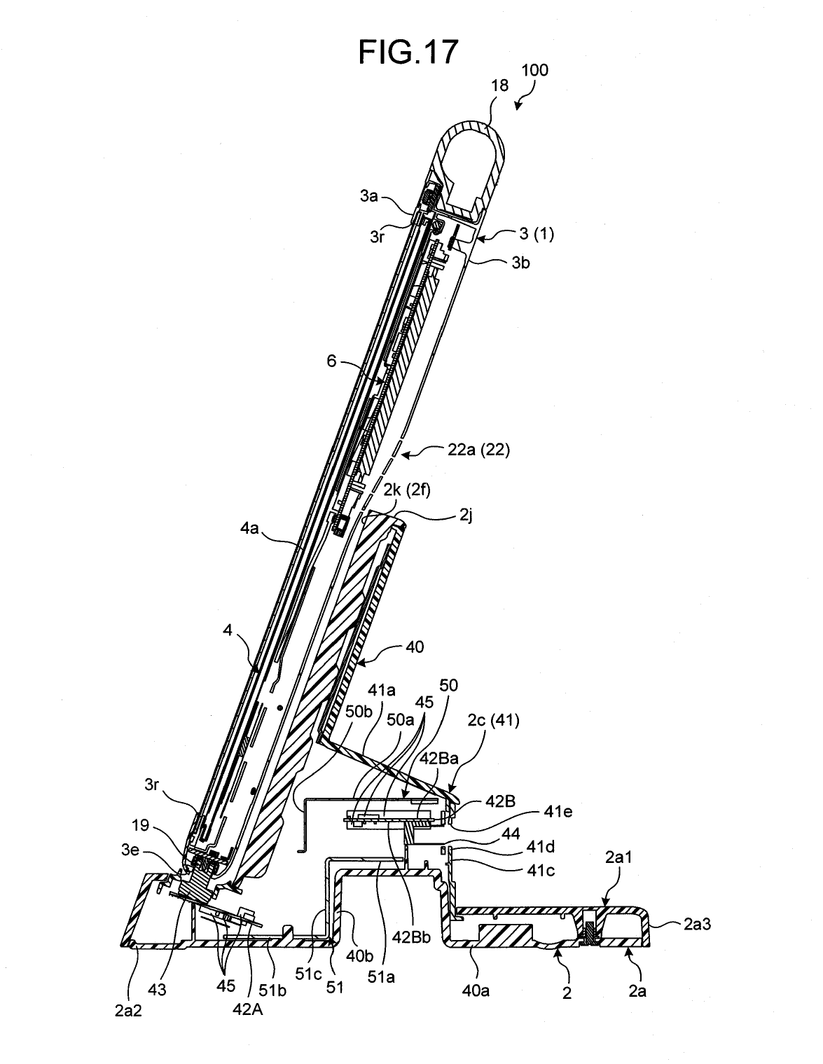

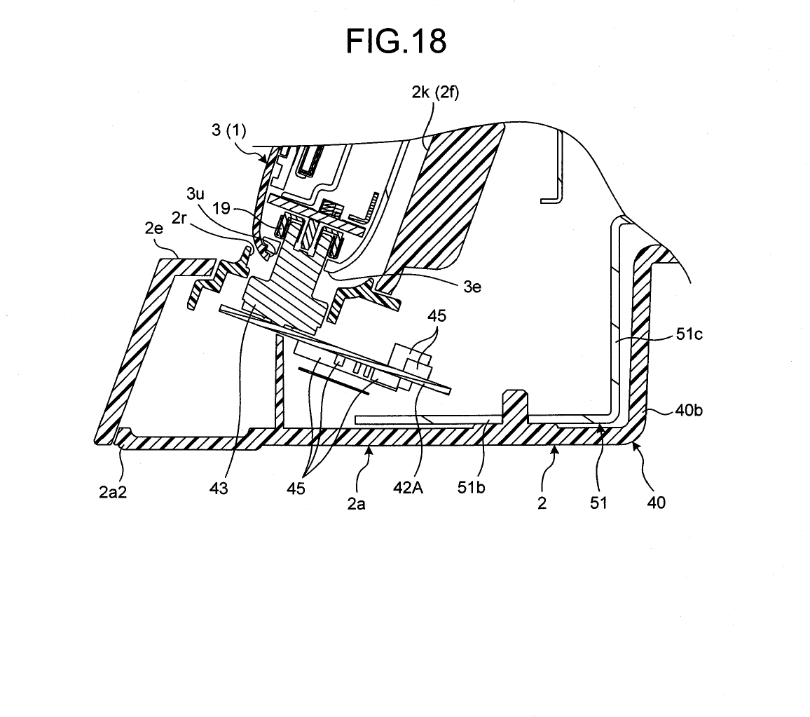

In the present embodiment, as an example, the stand 2 has at least partially a hollow structure. The stand 2 comprises the housing 40, which houses at least some of various components, such as boards 42A and 42B (refer to FIGS. 17 and 18), connectors 43 and 44, electronic components 45, and wire harnesses 46. The housing 40 can be composed of synthetic resin material or metallic material (synthetic resin material as an example in the present embodiment). In the present embodiment, as an example, the housing 40 is provided therein with a frame (frame member, framework member, high-stiffness member, stiffness member, or strength member) 47 (refer to, for example, FIG. 16). The frame 47 can be composed of metallic material or synthetic resin material (metallic material as an example in the present embodiment). The connector 43 is an example of a second connector. In the present embodiment, as an example, the board 42B as well as the connectors 44 and electronic components 45 provided on the board 42B are housed in the component housing 41 that is a part of the housing 40 and is configured as the projection 2c.

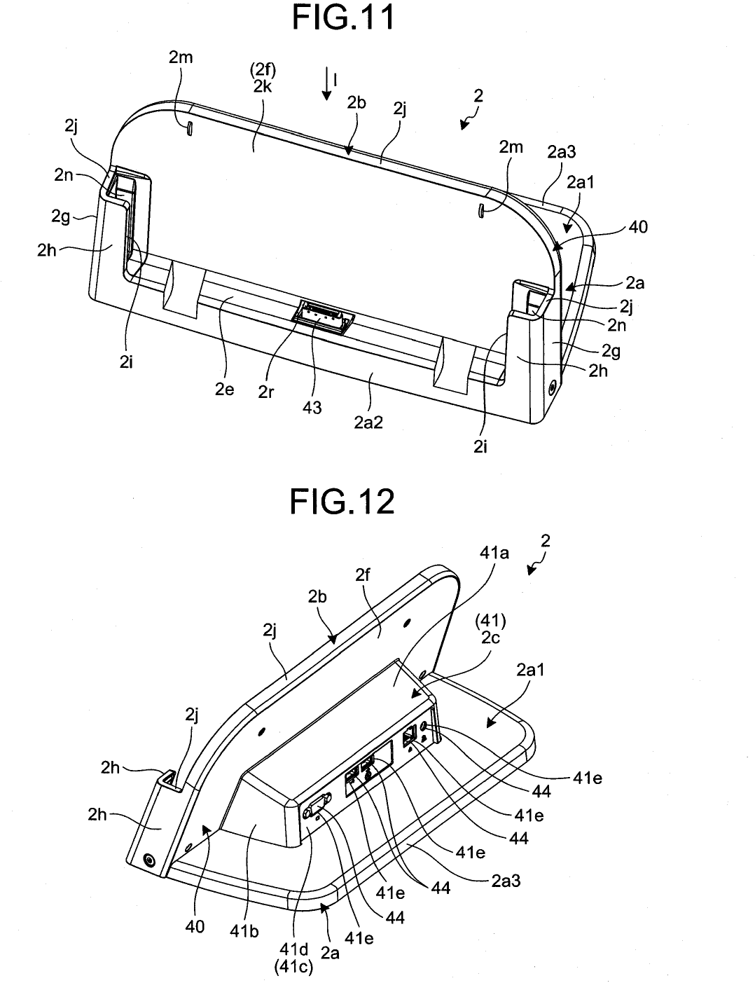

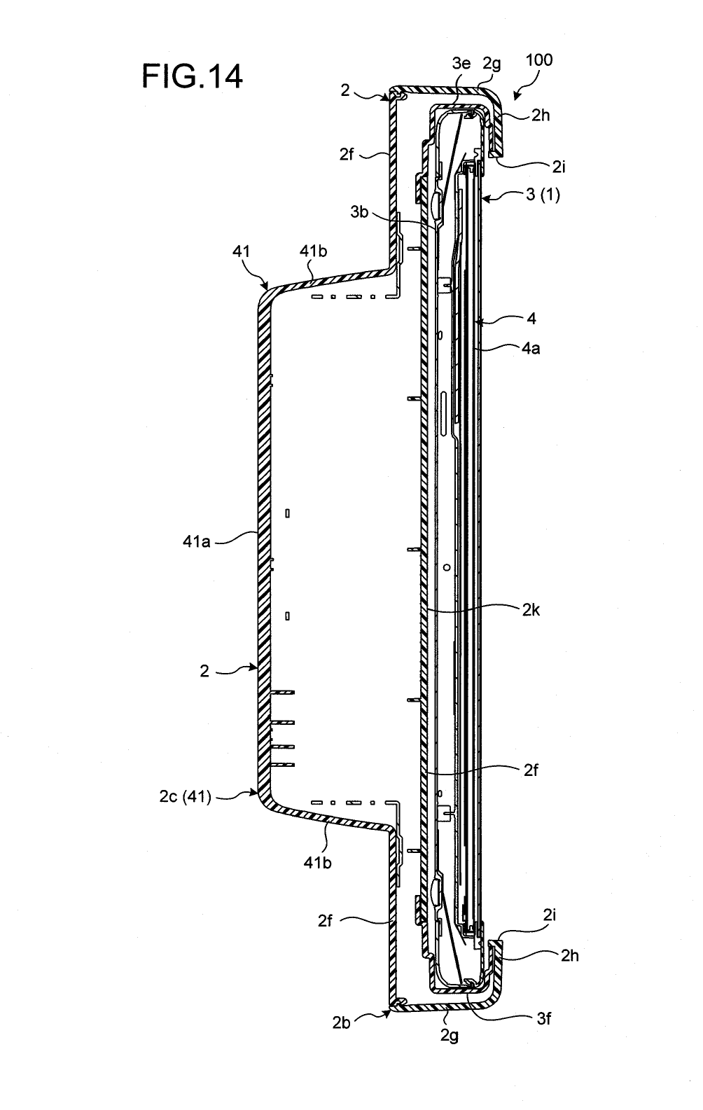

In the present embodiment, as an example, as illustrated in FIGS. 9 to 12, the first support 2a is configured to have a flat shape (plate shape, or wall shape) along the placing surface P, having an external appearance that is thin in a side view along the placing surface P (as viewed as illustrated in FIG. 9) and is rectangular (trapezoidal) in a plan view as viewed perpendicularly to the placing surface P. In the present embodiment, as an example, the second support 2b projects from an end 2a2 of the first support 2a in a direction slightly tilted rearward (toward the rear in the state in which the television receiver 1 is mounted, or toward an end 2a3 on the opposite side of the end 2a2) from the vertical. As illustrated in FIGS. 9 to 14, the second support 2b holds (supports, bears, or sustains) apart of an end (the end 3e as an example in the present embodiment) of the housing 3 of the television receiver 1 in a surrounding (covering) manner from directions except a direction (the upside as an example in the present embodiment) in which the television receiver 1 is mounted (inserted) into the predetermined position (holding position, or holding region), that is, from the downward, the rear side, the lateral sides (left side and right side), and the front side. The second support 2b can also cover a portion along the end 3e (refer to FIGS. 2 and 3). The second support 2b also serves as a guide that guides the housing 3 of the television receiver 1 into the predetermined position when the television receiver 1 moves (slides, is displaced, is inserted, or is mounted) toward the predetermined position of the stand 2. That is, the second support 2b is an example of a guide (guide module, slide, or slide module). In the present embodiment, as an example, the second support 2b comprises walls 2e to 2h. The wall (first wall, first wall portion, bottom wall, or lower wall) 2e is located below the housing 3 held in the predetermined position, and covers the housing 3 from below. The wall (second wall, second wall portion, rear wall, or back wall) 2f is located behind the housing 3, and covers the housing 3 from behind (rear side, rear surface side, back surface side, or behind side behind). The wall (third wall, third wall portion, or side wall) 2g is located lateral to the housing 3, and covers the housing 3 from the lateral side. The wall (fourth wall, fourth wall portion, or front wall) 2h is located in front of the housing 3, and covers the housing 3 from the front. Note that the wall 2e can be configured as a part of the first support 2a.

In the present embodiment, as an example, the stand 2 covers the television receiver 1 in the state in which a functional portion of the television receiver (electronic device) 1 is exposed, or in the state in which the functional portion is in communication with the surrounding area of the stand 2. As an example, in the present embodiment, as illustrated in FIGS. 1 and 11, the second support 2b is provided with an opening 2i corresponding to the front of the television receiver 1. The opening 2i can be provided, for example, as a notch or a through-hole (notch as an example in the present embodiment). That is, in the present embodiment, when the television receiver 1 is in the attitude of being mounted on the stand 2, if portions of the front surface 3a of the housing 3 along the ends 3d and 3f located on both the right and left sides are outside of the display screen 4a and the opening 3r, the portions are covered by (the wall 2h of) the second support 2b. With such a configuration, as an example, visibility of the display screen 4a can easily be ensured. Note that the television receiver 1 may be covered by a member (such as the second support 2b, the first support 2a, a part of the housing 40, or a member other than the housing 40) covering the end 3e located below the front surface 3a of the housing 3.

In the present embodiment, as an example, the stand 2 holds the television receiver 1 in the state in which the vent holes 22 provided at the housing 3 of the television receiver 1 are exposed. As illustrated in FIGS. 2, 4, and 5, the vent holes 22 are provided at the second portion 3Bb and the slope portion 3Bc of the housing 3. As can be understood from FIGS. 1, 9, and 10, the vent holes 22 are located above an end (edge, or side) 2j on the upper side of various portions of the second support 2b, and are exposed without being covered by the stand 2. Consequently, as an example, it is easy to prevent the stand 2 from hampering the air (air flow) through the vent holes 22. The openings 3u of the connectors 21, the opening 17a of the component housing 17 housing the component 16, and the openings 3u of the operation modules 20 provided at the housing 3 are also exposed. Therefore, in the present embodiment, as an example, it is easy to prevent the stand 2 from hampering access and operation of components or fingers to the openings 3u and 17a. In addition, with the above-described configuration, the second portion 3Bb which is an example of a region with large heat generation in the housing 3 is exposed from the stand 2. Consequently, as an example, a heat radiation property is likely to be higher than in the case in which the second portion 3Bb is covered by the stand 2. Also, as an example, the cooling efficiency can easily be increased.

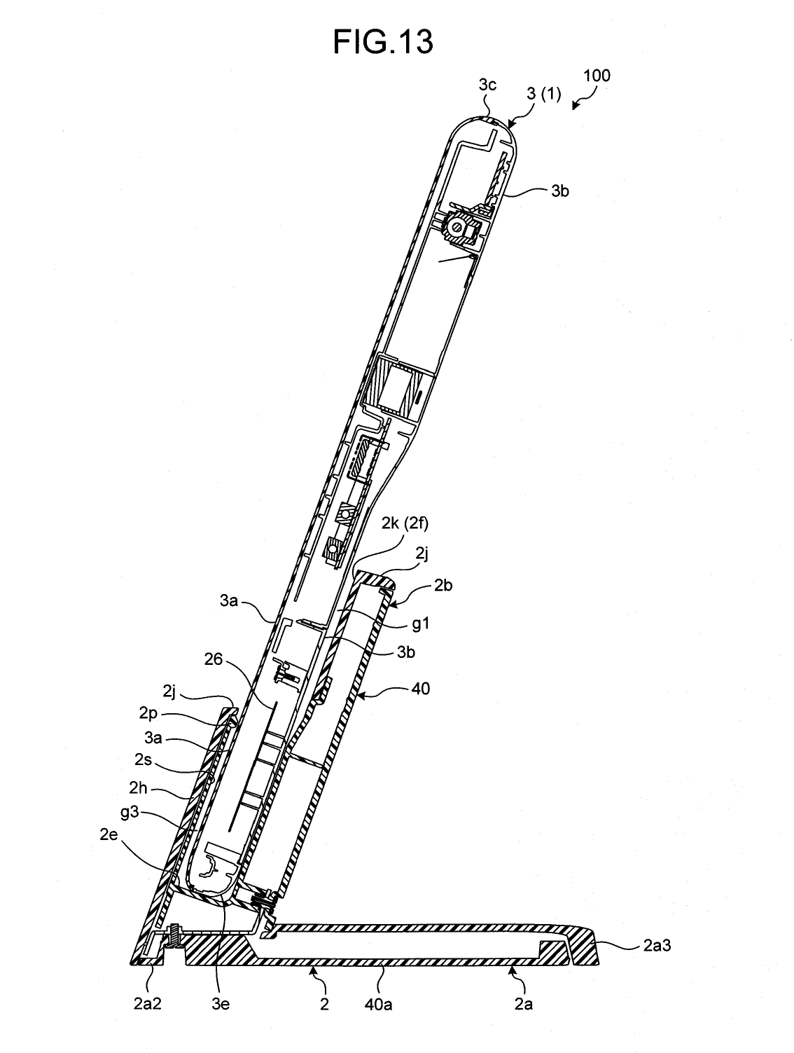

In the present embodiment, as an example, as illustrated in FIGS. 9, 11, and 13, a surface (front surface) 2k of the wall 2f supporting the housing 3 comprises projections (protrusions) 2m and 2n. Specifically, as illustrated in FIG. 11, a plurality (two as an example in the present embodiment) of such projections 2m are arranged with a space therebetween along the end 2j of the wall 2f. The projections 2m extend each with a substantially constant width along an in-out direction (forward-backward direction, insertion direction, insertion-removal direction, or mounting direction) I of the housing 3 relative to the stand 2. As illustrated in FIG. 9, an outer edge (end edge, front edge, top end, or front end) of each of the projections 2m is curved so as to forma convex shape toward the direction of a normal line from the wall 2f. In addition, as illustrated in FIG. 11, a plurality (two as an example in the present embodiment) of such projections 2n are each located along an end meeting the wall 2g. The projections 2n extend each with a substantially constant width along the in-out direction I of the housing 3 relative to the stand 2. As illustrated in FIG. 13, an outer edge (end edge, front edge, top end, or front end) of each of the projections 2n extends in a planar manner along the surface 2k of the wall 2f alongside the surface 2k. The projections 2m and 2n come in contact with the rear the method further comprising surface (surface, or second surface) 3b of the housing 3. The projections 2m and 2n are provided at different locations from each other with spaces therebetween along the in-out direction of the housing 3 relative to the stand 2, and are also provided at different locations from each other with spaces therebetween along the direction perpendicular to the in-out direction. Consequently, according to the present embodiment, as an example, the housing 3 of the television receiver 1 located in the predetermined position is supported from behind (rear side, rear surface side, back surface side, or side behind) in a more stable manner by the projections 2m and 2n which are arranged at the plurality of locations with spaces therebetween. As illustrated in FIG. 13, the projections 2m and 2n provide a space between the surface 2k of the wall 2f and the rear surface 3b of the housing 3, and thus, provide a gap g1 between the surface 2k and rear surface 3b. Consequently, in the present embodiment, as an example, the housing 3 of the television receiver (electronic device) 1 is prevented from being difficult to move relative to the stand 2 due to increase in frictional force caused by contact between the surface 2k and rear surface 3b. In addition, as an example, an air flow in the gap g1 is likely to be ensured, and thus, the cooling performance can easily be increased by that much. In the present embodiment, as an example, as illustrated in FIG. 13, a back side (rear side, rear surface side, back surface side, or side behind) of the wall 2h comprises a projection 2p. The projection 2p comes in contact with the front surface (surface, or first surface) 3a of the housing 3. A gap g3 is provided between the surface 3a of the housing 3 and a surface (back surface, or rear surface) 2s of the wall 2h. The projection 2p can also contribute to more stable holding of the housing 3 of the television receiver 1 in the predetermined position.

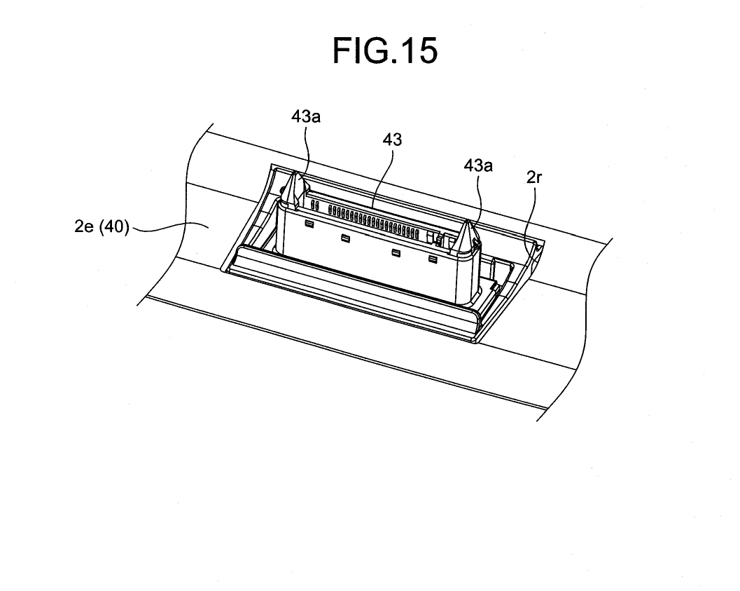

In the present embodiment, as an example, as illustrated in FIGS. 11 and 15, the wall 2e is provided with an opening 2r, and the connector 43 is exposed from the opening 2r while projecting above the wall 2e. As illustrated in FIGS. 17 and 18, the connector 43 enters the housing 3 from the opening 3u of the housing 3 of the television receiver 1 and is connected to the connector 19, thus being electrically connected with the connecter 19. Note that a corner serving as a side end as well as a leading end of the connector 43 comprises a projection (protrusion, or guide) 43a serving as a guide at the time of connection with the connector 19.

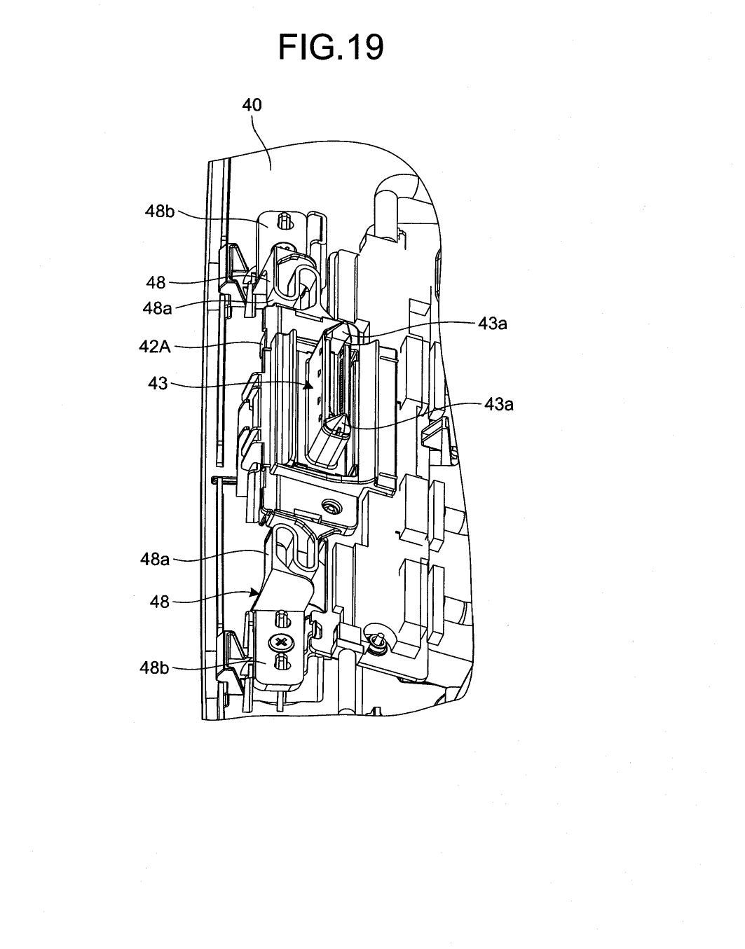

In the present embodiment, as an example, the connector 43 is fixed to the board 42A as illustrated in FIGS. 16 to 19. Also, in the present embodiment, as an example, the connector 43 and the board 42A are supported by the housing 40 via an elastic module 48, as illustrated in FIGS. 16 and 19. Specifically, the elastic module 48 comprises an elastic material (such as metallic material, synthetic resin material, or elastomer) in at least apart (arm 48a) thereof. The elastic module 48 comprises the arm (extension, hanger, joint, bridging portion, bridge, displacement portion, elastic deformation portion) 48a and a fixed portion 48b. The arm 48a bridges between the board 42A to which the connector 43 is fixed and the fixed portion 48b fixed to the housing 40. An elastic force (elastic repulsion), a hardness, an amount of displacement, and an insertion force (pressing force when mounting) of the elastic module 48 can be variably set according to specifications (such as material, shape, direction, length, width, height, thickness, and curvature of curved portion) of the arm 48a. As an example, the arm 48a is bent in an S-shape. The fixed portion 48b is connected to the housing 40 with a connecting device such as a screw 49. In the present embodiment, as an example, the connector 43 is supported at both ends thereof by two of the elastic modules 48. That is, the connector 43 is interposed between the two elastic modules 48. With such a configuration, as an example, the connector 43 is likely to be supported in a more stable manner than in the case of being supported by a cantilever. In the present embodiment, as an example, the arm 48a is a strip-shaped and plate-shaped member having a surface along the in-out direction of the housing 3 of the television receiver 1 relative to the stand 2, and is bent along a direction intersecting (in the present embodiment, as an example, along a direction or a surface perpendicular to) the in-out direction. Consequently, the arm 48a can easily be displaced in the direction intersecting the in-out direction, but can hardly be displaced in the in-out direction. Therefore, according to the present embodiment, as an example, when the housing 3 of the television receiver 1 is displaced from the predetermined position in the direction intersecting the in-out direction, the connector 43 easily moves corresponding to the displacement. That is, the connector 43 which is allowed to be elastically displaced can easily absorb the displacement of the connector 19 relative to the predetermined position. Also, according to the present embodiment, as an example, the connector 43 can be held more tightly against the connector 19 of the television receiver 1 which moves along the in-out direction. Consequently, as an example, the television receiver (electronic device) 1 can easily be mounted to and removed from the stand 2. That is, according to the present embodiment, because the elastic module 48 (arm 48a) is provided which has a different elasticity (stiffness) depending on the direction, it is easy, as an example, to satisfy both ease of absorbing (coping with) the displacement and ease of mounting and removal.

In the present embodiment, as an example, as illustrated in FIG. 17, in addition to the board 42A comprising the connector 43 to which the connector 19 of the television receiver 1 (electronic device supported by the stand 2) is connected, the housing 40 comprises therein the board 42B comprising the connectors 44 (such as a power connector, a video signal connectors [such as an HDMI connector, a D-terminal connector, and a DV-terminal connector], audio signal connectors [such as a phone plug connector and a DIN connector], data signal connectors [such as a USB connector, a LAN connector, and an RS-232C connector], a connector for electromagnetic waves [such as a coaxial cable connector], and a fiber optic connector) other than the connector 43. That is, in the present embodiment, as an example, the housing 40 comprises therein the plurality (two as an example in the present embodiment) of boards 42A and 42B. The board 42B is located with a distance from the board 42A. In the present embodiment, as an example, the board 42B is located on the rear side of the board 42A (on the side opposite to the display screen 4a). The board 42A and the board 42B are also spaced from each other in the height direction. In the present embodiment, as an example, the board 42B is provided in a position higher (farther from the placing surface P) than that of the board 42A. In this manner, because the plurality of boards 42A and 42B are arranged in a spaced manner from each other, it is easy to improve a freedom of component layout as an example, and it is easy to configure the stand 2 to have a smaller size as an example. In addition, effects are obtained such that, as an example, positions of the connectors 44 provided on the board 42B can be set independently of positions of the board 42A and the connector 43, and such that, as an example, access and operation of components or fingers to the connectors 44 are easily prevented from being hampered. Moreover, as an example, the connectors 44 can be provided at locations where access and operation of components or fingers can be performed more easily.

In the present embodiment, as an example, as illustrated in FIGS. 16 and 17, the board 42B as well as the connectors 44 and the electronic components 45 provided on the board 42B are covered by shield members (shields, covering members, covers, surrounding members, cover members, shielding members, conductors, or conductive members) 50 and 51 in the component housing 41 (housing 40). Specifically, the shield member 50 comprises a plurality of walls 50a to 50c, and the shield member 51 comprises a plurality of walls 51a to 51c. A surface (first surface, or upper surface) 42Ba of the board 42B and a surface (second surface, or lower surface) 42Bb on the opposite side thereof are provided alongside (in the present embodiment, as an example, in parallel with) the placing surface P. The wall 50a is provided alongside (in the present embodiment, as an example, in parallel with) the surfaces 42Ba and 42Bb of the board 42B, and covers the board 42B from above. The wall 50b extends in a direction intersecting (in the present embodiment, as an example, perpendicular to) the wall 50a, and covers the board 42B from the front (the television receiver 1 side). The wall 50c extends in a direction intersecting (in the present embodiment, as an example, perpendicular to) the walls 50a and 50b, and covers the board 42B from the lateral side (in the right-left direction in the front view of the television receiver 1, that is, from the right-left side in FIG. 16). The wall 51a is provided alongside (in the present embodiment, as an example, in parallel with) the surface 42Bb of the board 42B, and covers the board 42B from below. The shield members 50 and 51 are composed of conductive material or magnetic material, as an example. In this manner, in the present embodiment, as an example, the board 42B as well as the connectors 44 and the electronic components 45 provided on the board 42B are covered by (the walls 50a to 50c, and the wall 51a of) the shield members 50 and 51. Consequently, as an example, noise is easily prevented from being mixed into electrical signals, and thus, easily prevented from adversely affecting the electrical signals in circuits related to the board 42B, the connectors 44, and the electronic components 45. In addition, as an example, the stiffness of the housing 40 is easily increased by the shield members 50 and 51. Moreover, because the shield member 50 is provided in a box shape, the stiffness of the housing 40 is more easily increased, as an example. In the present embodiment, as an example, as illustrated in FIG. 17, the shield member 51 comprises the wall 51b that is provided alongside (in the present embodiment, as an example, in parallel with) the wall 51a at a location nearer to the placing surface P than is the wall 51a (lower than the wall 51a) in a spaced manner from the wall 51a, and comprises also the wall 51c that extends in a direction intersecting (in the present embodiment, as an example, perpendicular to) the walls 51a and 51b, and that bridges between the wall 51a and the wall 51b. Consequently, according to the present embodiment, by virtue of the shield member 51, noise is more easily prevented from being mixed into electrical signals, as an example, and the stiffness of the housing 40 is more easily increased, as an example. According to the present embodiment, as an example, the shield members 50 and 51 can also serve as a part of the frame 47. In the present embodiment, as an example, as illustrated in FIG. 16, the frame 47 that is separate from the shield members 50 and 51 is provided along the wall 2f in the housing 40. The frame 47 that is configured to have a plate shape comprises a plurality of projections (backbones) 47a, and is provided with a plurality of through-holes 47b. Consequently, as an example, the frame 47 can be configured to be lighter in weight, and the stiffness of the housing 40 is easily increased. In the present embodiment, as an example, the frame 47 is composed of a conductor (conductive material), and the frame 47 and the shield members 50 and 51 are electrically connected with each other and set to a ground potential. Consequently, in the present embodiment, as an example, noise is more easily prevented from being mixed into electrical signals. The frame 47 is an example of a shield member. The shield members 50 and 51 are examples of frames.

In the present embodiment, as an example, as illustrated in FIGS. 13 and 16, none of the shield members 50 and 51, and the frame 47 is provided in portions corresponding to the walls 2g and 2h of the second support 2b. In addition, the walls 2g and 2h are composed of a nonconductor (nonconductive material, such as synthetic resin material as an example). The antennas 26 (refer to FIG. 7) are located at portions of the television receiver 1 corresponding to the walls 2g and 2h when the television receiver 1 is mounted on the stand 2. Consequently, according to the present embodiment, as an example, it is easy to prevent communication performance of the antennas 26 from being degraded due to the shield member 50 or 51, or the frame 47. That is, in the present embodiment, as an example, the portions corresponding to the antennas 26 are electromagnetically exposed (not covered by a conductor) at least on one side (in the present embodiment, as an example, on the front and lateral sides in the front view of the display screen 4a in the state in which the television receiver 1 is mounted on the stand 2).

In the present embodiment, as an example, as illustrated in FIGS. 9, 10, 12, and 17, the component housing 41 comprises a wall (upper wall, top wall, or first wall portion) 41a located above, walls (side walls, vertical walls, standing walls, erect walls, or second wall portions) 41b located on both the right and left sides in the rear view (front view), and a wall (rear wall, back wall, or second wall portion) 41c located behind (on the behind side behind). The walls 41b are examples of ends on the lateral sides of the component housing 41. The wall 41c is an example of an end behind the component housing 41.

In the present embodiment, as an example, as illustrated in FIGS. 10, 12, and 17, the connectors 44 are exposed from openings 41e provided at a surface 41d of the wall 41c of the component housing 41 (housing 40). In the present embodiment, as an example, the end 2a3 of the first support 2a is located on the open side of the connectors 44 (on the open side of the openings 41e, or on the opening side; in the present embodiment, as an example, on the rear side) with a space from the wall 41c (surface 41d, or end). That is, in the present embodiment, as an example, the first support 2a is provided, on the rear side of the wall 41c, with a projection (overhang, flange, extension, peripheral side, peripheral edge, bottom, bed, leg, or wall) 2a1. Although the projection 2a1 is provided in a flat plate shape as an example in the present embodiment, it can be configured to have various shapes. For example, the projection 2a1 can have a strip shape, a bar shape, a mesh shape, and a ring shape, or can be provided with openings, such as notches and through-holes, as well as undulated portions. In the present embodiment, as an example, the projection 2a1 covers from below such things as connectors and cables (wire harnesses, or wiring) (not shown) connected to the connectors 44. That is, the projection 2a1 is an example of a cover (cover module, or protection module). Because the projection 2a1 projects from the wall 41c, the connectors, cables, or the like connected to the connectors 44 are prevented from being touched by other objects (such as walls, equipment, and components). That is, the projection 2a1 is an example of a suppression module (protection module). The projection 2a1 also extends along the placing surface P (refer to FIG. 9) in directions intersecting the rearward direction (in the orthogonal directions, that is, in the right and left directions in the front and rear views, as an example in the present embodiment). That is, the projection 2a1 also projects in the lateral directions from the walls 41b. Consequently, as an example, it is easy to ensure a space (region) through which the connectors and cables pass above the projection 2a1. Note that the projection 2a1 can comprise mechanisms (such as projections, walls, recesses, grooves, locking portions, and hooks) for hooking and fixing the cables. In addition, the walls 41b may be provided with the openings 41e, and the connectors may be exposed from the openings 41e.

In the present embodiment, as an example, as illustrated in FIG. 17, a wall (bottom wall, or bottom) 40a of the housing 40 is dented (projected), and thus, comprises a projection (recess) 40b projecting in a direction departing (upward) from the placing surface P. The board 42B is connected to the projection 40b with a connecting device such as a screw (not shown). Consequently, according to the present embodiment, as an example, the configuration in which the board 42B is provided at a location apart from the placing surface P can be obtained with a simpler configuration. In addition, as an example, the stiffness of the housing 40 is easily increased by the projection 40b.

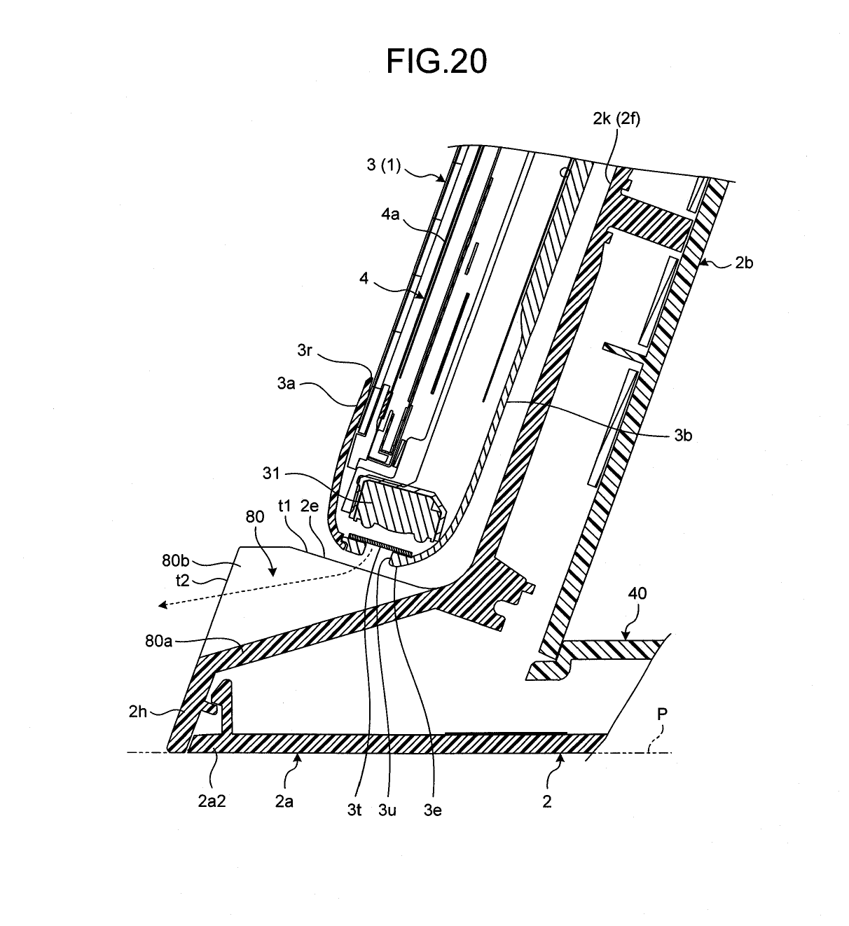

In the present embodiment, as an example, as illustrated in FIGS. 1 and 20, notches 80 (cutouts, openings, or recesses) are provided so as to face the openings 3u corresponding to speakers 31 provided in the housing 3, that is, the openings 3u (refer to FIG. 2) provided with the speaker covers 3t covering the speakers 31, in the state in which the television receiver 1 is located in the predetermined position of the stand 2. In the present embodiment, as an example, as illustrated in FIGS. 1 and 2, the speaker covers 3t, the openings 3u, and the notches 80 are provided at two locations on both the right and left sides in the front view of the display screen 4a. The speakers 31 are provided corresponding to the respective speaker covers 3t.

The notches 80 are provided at corners of each serving as a boundary portion (joint portion, or intersecting portion) between the wall 2e and the wall 2h of the stand 2. The notches 80 each comprises an end t1 on the side of the wall 2e facing the opening 3u, and an end t2 on the side of the wall 2h located on the front face side (that is, on the forward side) of the display screen 4a. In addition, the notches 80 are each configured as a recess (recessed groove) comprising walls 80a and 80b. The two walls 80a extend intersecting (in the present embodiment, as an example, perpendicularly to) the placing surface P, and face each other with a space therebetween. The wall 80a bridges between the two walls 80b, and extends intersecting the walls 80b. The walls 80a and 80a configure the notches 80 as the recessed grooves each extending along a normal line of the display screen 4a.

In the configuration as described above, the notches 80 constitute each at least a part of a propagation path of sound S emitted from the opening 3u. Each of the notches 80 is located immediately or directly in the propagation path of sound S emitted from the opening 3u. Here, the wall 80a comes closer to the placing surface P as it extends from the end t1 toward the end t2. Consequently, according to the present embodiment, the sound S emitted from the opening 3u easily proceeds toward the direction in which the notch 80 extends, that is, toward the direction along the wall 80a, by, for example, being reflected by the walls 80a and 80b, and the housing 3. With such a configuration, the user may easily hear the sound S by virtue of reflection on the placing surface P.

In the present embodiment, as an example, the stand 2 covers both sides in the lengthwise direction of the end 3e of the housing 3 with the walls 2g and 2h (covers), as illustrated in FIG. 1. In the case of such a configuration, a larger region (area) on the surfaces (front surface 3a, rear surface 3b, and side surfaces 3p) of the housing 3 is covered by the stand 2. Therefore, from the viewpoint of difficulty in ensuring the exposed openings 3u, more restrictions maybe imposed on the layout of the openings 3u, and consequently, the speakers 31. In this respect, according to the present embodiment, a part of the propagation paths of the sound S can be formed by providing the notches 80 even in the portions covered by the stand 2 on the surface of the housing 3. Consequently, as an example, the user can easily hear the sound S at a higher sound volume. That is, in other words, it is easy to improve a freedom of layout of, for example, the speakers 31 in the housing 3 by providing the notches 80. Therefore, as an example, it is easy to satisfy both the stiffness for supporting the housing 3 by the stand 2, and ensuring of a sound volume of the sound S from the speakers 31.

In the present embodiment described above, as an example, the stand 2 is provided with the notches 80 that are located corresponding to the openings 3u from which the sound S from the speakers 31 is output and that constitute at least a part of the propagation paths of the sound S output from the openings 3u. Consequently, according to the present embodiment, as an example, the sound S from the speakers 31 can be heard more easily than in the case in which the openings 3u are closed by the wall 2e of the stand 2. In addition, as an example, it is easy to improve the freedom of layout of the speakers 31 in the housing 3.

In the present embodiment, as an example, the end t2 of the notch 80 on the side away from the opening 3u of the corresponding speaker 31 is open to the front side of the display screen 4a. Consequently, according to the present embodiment, as an example, the user located on the front side of the display screen 4a can hear more easily the sound S from the speakers 31.

In the present embodiment, as an example, the wall 80a of the notch 80 is provided so as to approach the placing surface P as the wall 80a extends from the end t1 toward the end t2. Consequently, according to the present embodiment, the sound S from the speakers 31 easily proceeds toward the placing surface P as an example, and the sound S can be heard easily by virtue of the reflection on the placing surface P as an example.

First Variation

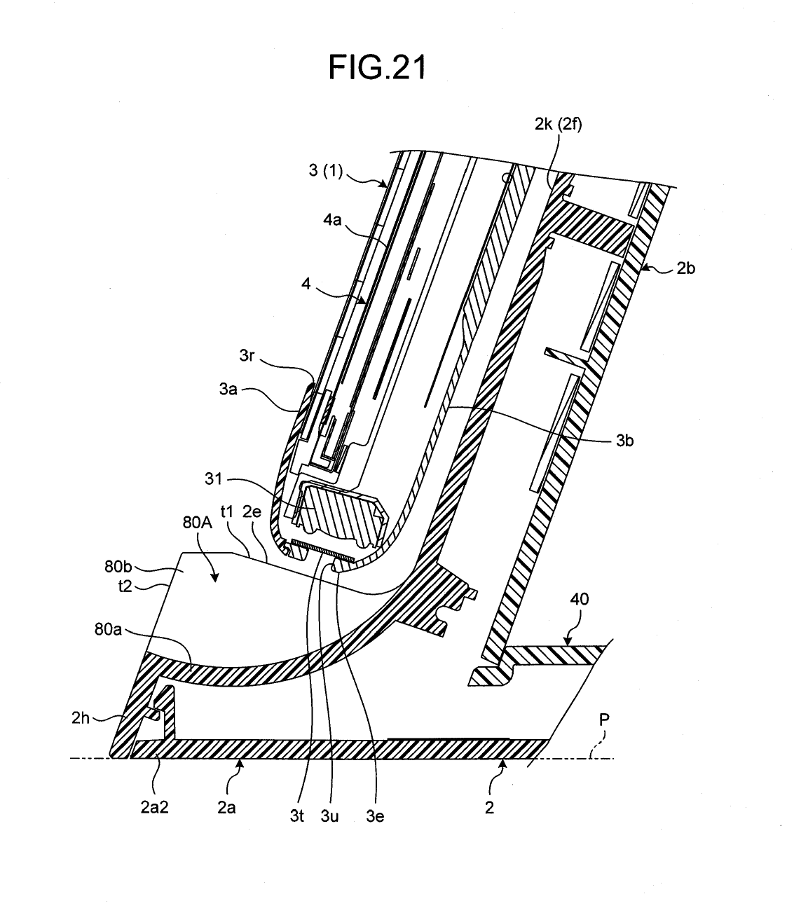

In the present variation, as an example, the stand 2 has notches 80A, as illustrated in FIG. 21, that are similar to those of the first embodiment described above. Therefore, similar results to those of the first embodiment can also be obtained by the present variation. However, in the present variation, as illustrated in FIG. 21, the wall 80a is curved to be placed in a state in which the stand 2 forms a convex shape toward the placing surface P and toward a side opposite to the display screen 4a. The wall 80a is an example of a curved portion. According to the present variation, as an example, the curvature of the wall 80a facilitates setting of a place at which the sound S can easily be heard. The position and shape of the curve can be changed as appropriate.

Second Variation

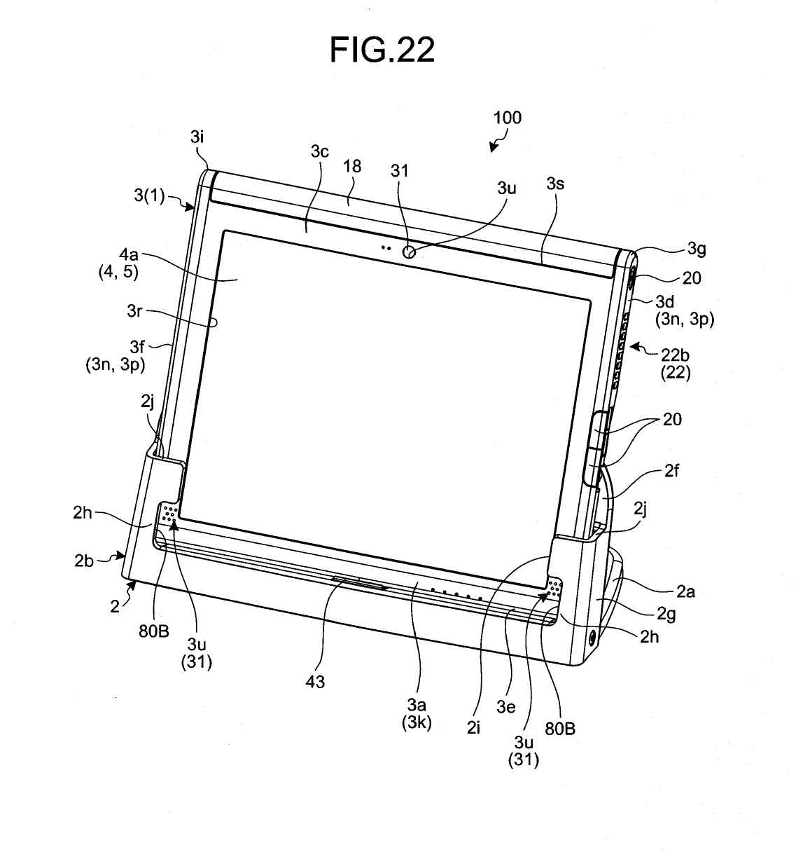

In the present variation, as an example, the stand 2 has notches 80B as illustrated in FIG. 22. The notches 80B are provided, as an example, at edges of the opening 2i of the wall 2h covering the front surface 3a of the housing 3. By virtue of the notches 80B, the openings 3u provided at the wall 3k of the housing 3 corresponding to the speakers 31 are exposed to the front side of the display screen 4a. Consequently, according to the present embodiment, as an example, the sound from the speakers 31 can be heard more easily than in the case of without the notches 80B, while the stiffness for supporting the housing 3 is ensured by the wall 2h.

Third Variation

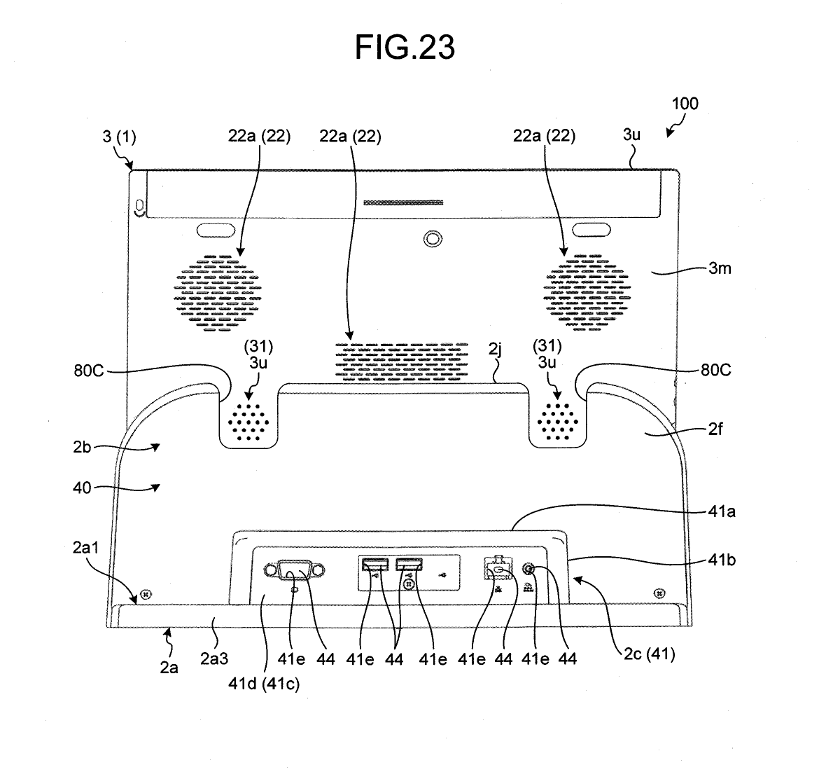

In the present variation, as an example, the stand 2 has notches 80C as illustrated in FIG. 23. The notches 80C are provided, as an example, at the end 2j of the wall 2f covering the rear surface 3b of the housing 3. By virtue of the notches 80C, the openings 3u provided at the wall 3m of the housing 3 corresponding to the speakers 31 are exposed to a side opposite to the display screen 4a. Consequently, according to the present embodiment, as an example, the sound from the speakers 31 can be heard more easily than in the case of without the notches 80C, while the stiffness for supporting the housing 3 is ensured by the wall 2f.

Fourth Variation

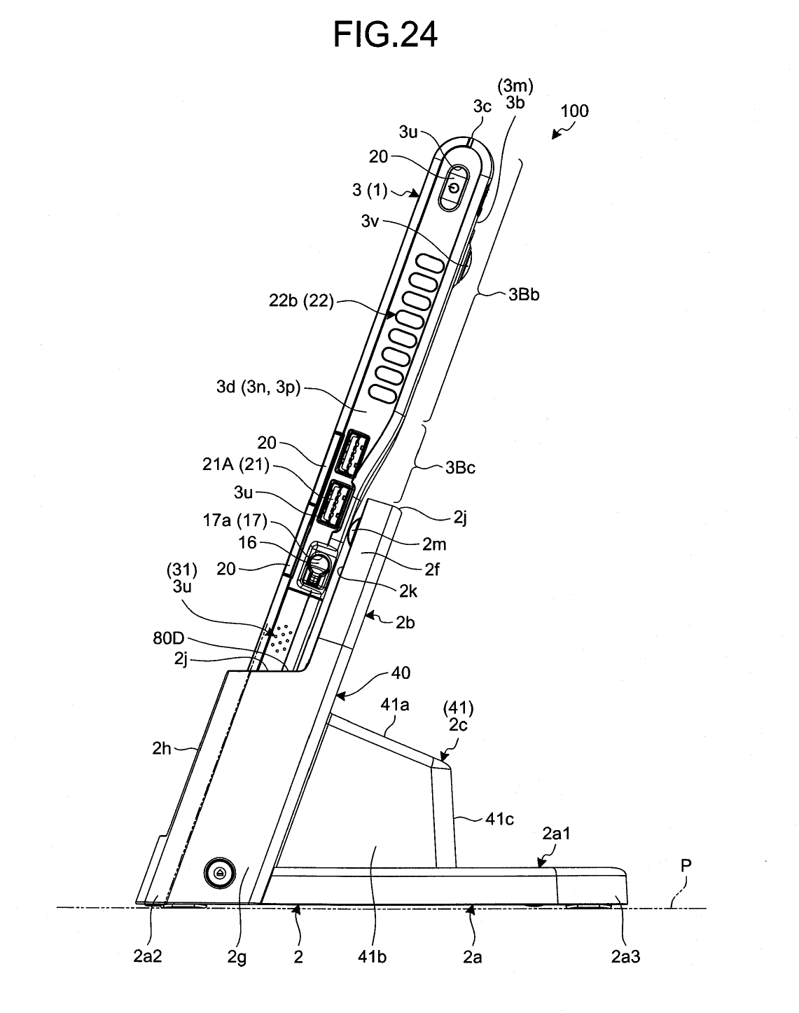

In the present variation, as an example, the stand 2 has a notch 80D as illustrated in FIG. 24. The notch 80D is provided, as an example, at an end (edge) of the wall 2g covering the side surface 3p of the housing 3, on the side farther from the placing surface P. By virtue of the notch 80D, the opening 3u for the corresponding speaker 31 provided at the wall 3n (end 3d) of the housing 3 is exposed in a direction (lateral side) along the display screen 4a. Consequently, according to the present embodiment, as an example, the sound from the speakers 31 can be heard more easily than in the case of without the notch 80C, while the stiffness for supporting the housing 3 is ensured by the wall 2f.

Fifth Variation

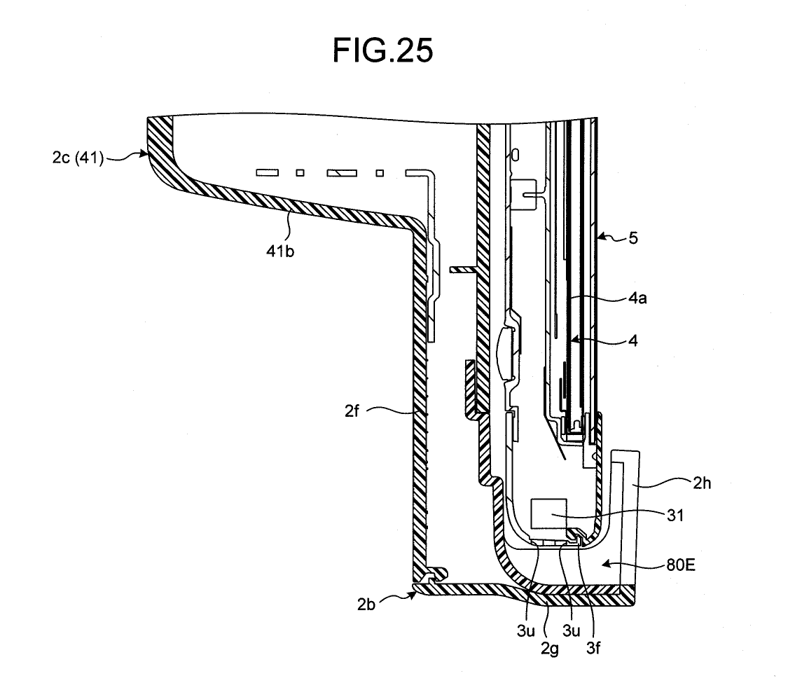

In the present variation, as an example, the stand 2 has an opening 80E as illustrated in FIG. 25. The opening 80E is provided, as an example, at the wall 2g covering the side surface 3p of the housing 3, as a portion partially bulging (projecting, or bent) in a direction departing from the end 3f of the housing 3. Consequently, according to the present embodiment, as an example, the sound from the speakers 31 can be heard more easily than in the case of without the opening 80E, while the stiffness for supporting the housing 3 is ensured by the wall 2g.

Sixth Variation

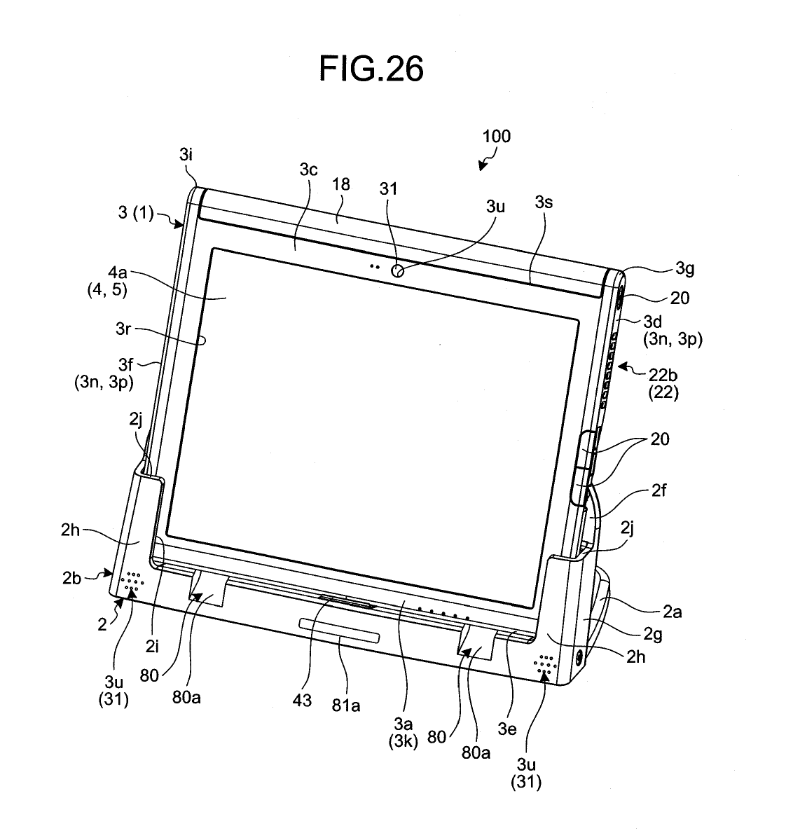

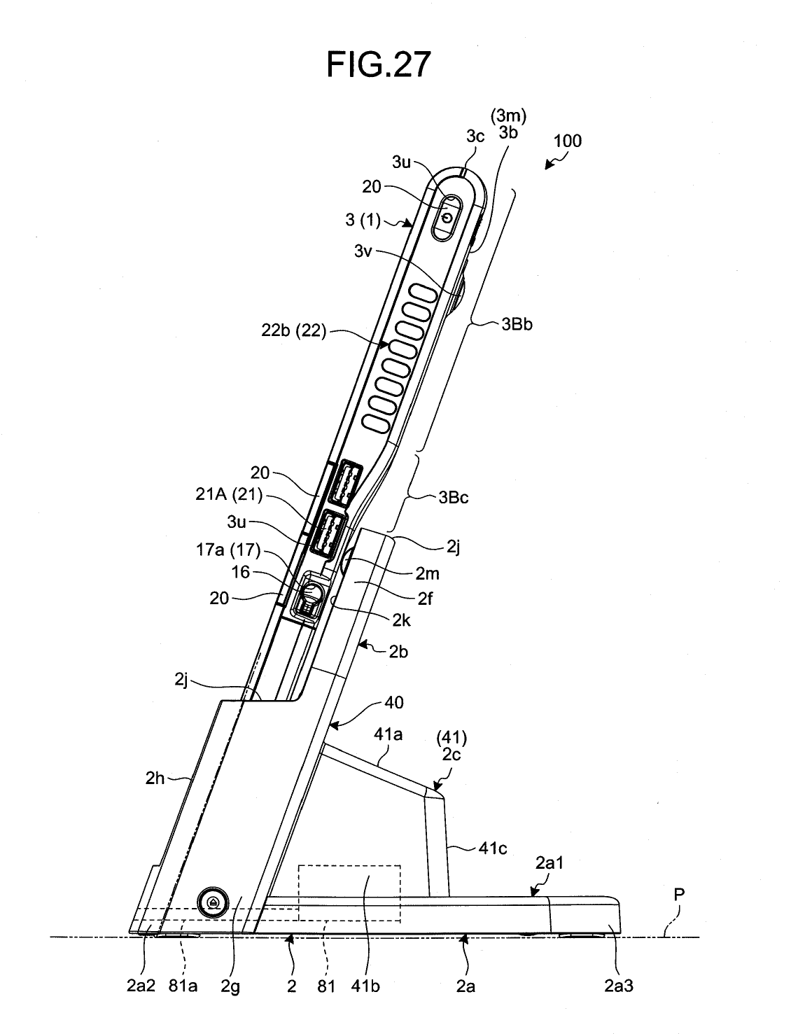

In the present variation, as an example, as illustrated in FIGS. 26 and 27, the stand 2 comprises speakers 31 and 81 in addition to having the same notches 80 as those of the first embodiment. The speakers 31 and 81 output sounds based on signals (such as audio signals) received from the television receiver 1 via the connectors 19 and 43 electrically connected to each other. Circuits such as amplifiers and controllers are formed, as an example, on the board 42B of the stand 2, and drive the speakers 31 and 81 to output sounds. In this case, for example, the speakers 31 can be configured as tweeters (speakers for high-pitched sound), and the speaker 81 can be configured as a woofer (subwoofer, or speaker for low-pitched sound). The speakers 31 are provided at the corners of the walls 2h at locations near the placing surface P. The sound output from the speakers 31 is emitted from the opening 3u. On the other hand, the speaker 81 is housed in the component housing 41 (housing 40) of the stand 2. The sound output from the speaker 81 is emitted to the front face side (front side) of the display screen 4a via a passage 81a provided in the housing 40. According to the present embodiment, as an example, the sounds can be emitted from the speakers 31 and 81 of the stand 2. Therefore, even if an output of sound is blocked by the stand 2 in the case in which the television receiver 1 is mounted on the stand 2, the output can be supplemented by the output of sounds from the speakers 31 and 81. In addition, as an example, sounds of better quality can be output.

Seventh Variation

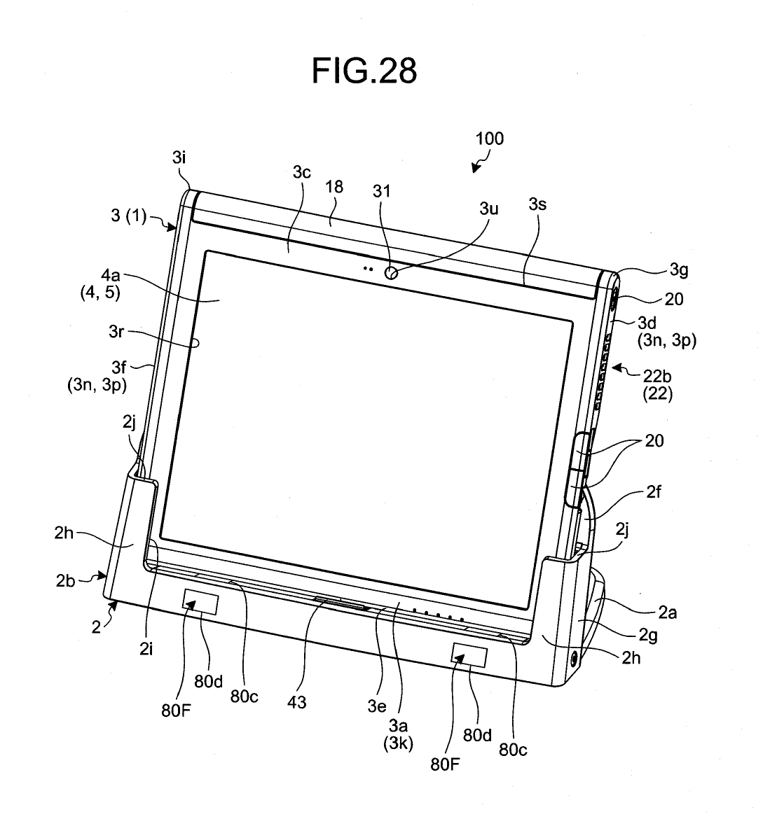

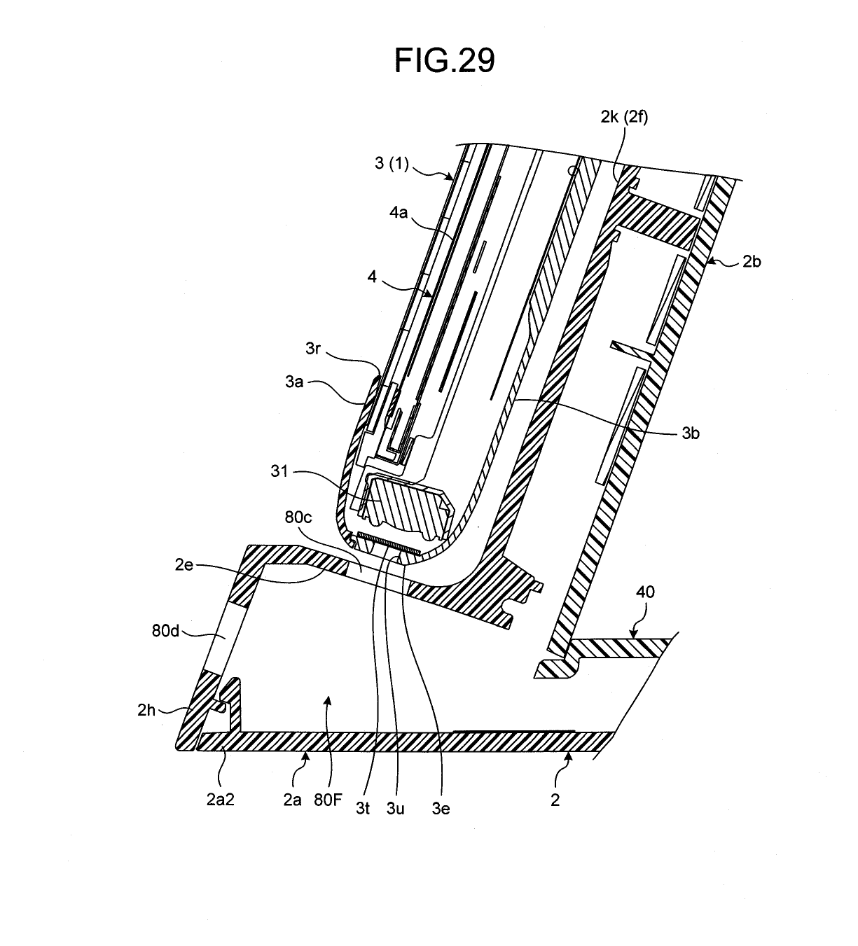

In the present variation, as an example, as illustrated in FIGS. 28 and 29, the stand 2 has openings 80F, each composed of an opening 80c and an opening 80d communicated with each other inside the housing 40. In this case, the housing 40 of the stand 2 serves as an enclosure of the speakers 31. The openings 80F have the openings 80c facing the openings 3u, and the openings 80d located on the side away from the openings 3u. The openings 80c are provided at the wall 2e, and the openings 80d are provided at the wall 2h. The same effects as those of the first embodiment described above can also be obtained by the present variation. In addition, sounds of better quality can easily be obtained because the housing 40 serves as an enclosure.

Eighth Variation

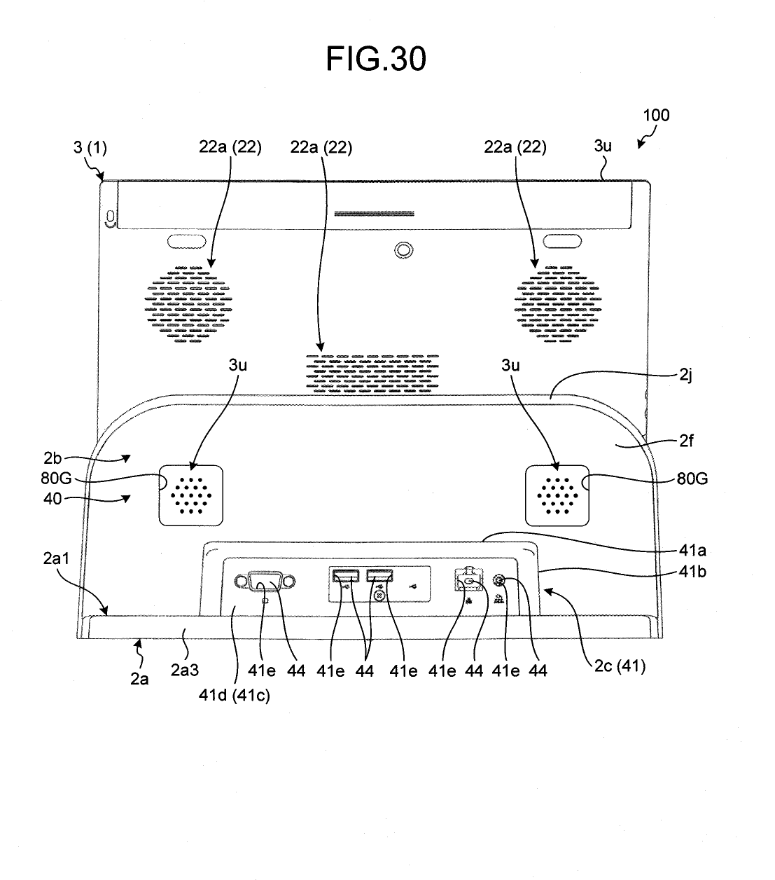

In the present variation, as an example, the stand 2 has openings 80G as illustrated in FIG. 30. The openings 80G are provided, as an example, as through-holes in the wall 2f covering the rear surface 3b of the housing 3. By virtue of the openings 80G, the openings 3u provided at the wall 3m of the housing 3 corresponding to the speakers are exposed to the side opposite to the display screen 4a. Consequently, according to the present embodiment, as an example, the sound from the speakers 31 can be heard more easily than in the case of without the openings 80G, while the stiffness for supporting the housing 3 is ensured by the wall 2f.

Ninth Variation

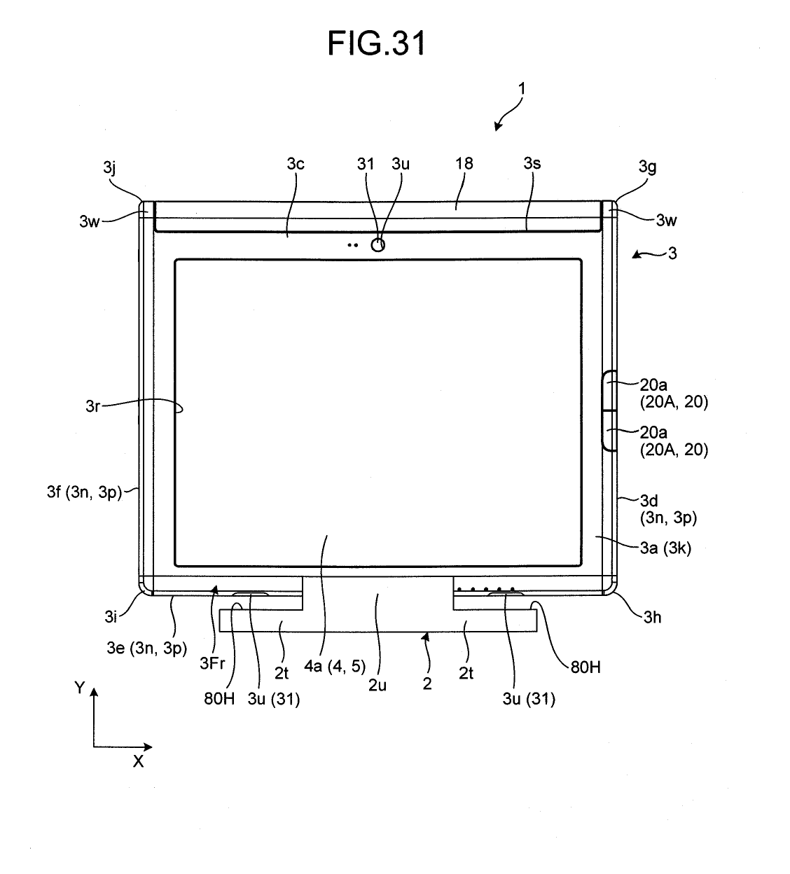

In the present variation, as an example, the stand 2 has notches 80H as illustrated in FIG. 31. The stand 2 comprises a base 2t (platform, or lower portion) that is placed on the placing surface, and a projection 2u (support, or upper portion) that is narrower in width than the base 2t in the front view and that projects from the base 2t. The support 2u supports the housing 3. The notches 80H are provided by the base 2t and the projection 2u. The openings 3u face the notches 80H. Consequently, also according to the present variation, the sound from the speakers 31 can be heard easily.

The embodiments have been described above. However, they are merely examples. Embodiments are not limited to the above-described ones, and various modifications are possible. For example, one of the features of the embodiments can be configured as a stand that comprises no connector. The technical features of the above-described embodiments including the variations can be combined as appropriate and put into practice. The specifications (such as structure, type, direction, shape, size, length, width, thickness, height, number, arrangement, position, and material) of each of the components can be changed as appropriate and put into practice.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A television receiver system comprising:
a housing configured to house a display, the housing comprising an opening configured to pass sound; and
a stand detachably connected to the housing, the stand configured to support the housing, the stand comprising a notch in a location corresponding to the opening, wherein the notch comprises at least a part of a propagation path of the sound.

2. The television receiver system of claim 1, wherein an end of the notch, on a side opposite the opening, is open to a front side of the display.

3. The television receiver system of claim 1, wherein a wall in the stand, comprising the notch, comprises a portion that extends, when the stand is placed on a placing surface, in a direction toward the placing surface as the portion extends from a side of the opening to a side opposite the opening.

4. The television receiver system of claim 1, wherein a wall in the stand, comprising the notch, comprises a curved portion that forms a convex shape, when the stand is placed on the placing surface, toward a side of the placing surface and toward a side opposite to the display.

5. The television receiver system of claim 1, wherein
the opening is located at a first end of the housing that is located, when the stand is placed on a placing surface, at a side of the placing surface, and
the stand comprises a cover configured to cover at least a part of an end in a lengthwise direction of the first end, and a wall portion that faces the first end, the notch located in the wall portion.

6. The television receiver system of claim 1, wherein the notch is in a position corresponding to the opening, the opening located on a side opposite to the display.

7. The television receiver system of claim 1, wherein the notch is in a position corresponding to the opening, the opening located at an end of a peripheral edge of the display.

8. The television receiver system of claim 1, wherein the stand comprises a speaker configured to emit sound based on a signal received from the housing.

9. The television receiver system of claim 8, wherein the speaker comprises a woofer.

10. A stand for a television receiver detachably connected to a housing that is configured to house a display, the housing comprising an opening configured to pass sound, the stand configured to support the housing, the stand comprising a notch in a location corresponding to the opening and comprising at least a part of a propagation path of the sound.

11. An electronic device system comprising:
a housing configured to house a display, the housing comprising an opening configured to pass sound; and
a stand detachably connected to the housing, the stand configured to support the housing, the stand comprising a notch in a location corresponding to the opening and comprising at least a part of a propagation path of the sound.
